(19) United States
(12) Patent Application Publication
(10) Pub. No.: US 2026/0128214 A1
(43) Pub. Date: May 7, 2026

(54) METHODS AND APPARATUS FOR MAINTAINING ELECTRIC VEHICLE BATTERY AT ITS OPTIMAL OPERATING AND CHARGING TEMPERATURE

(71) Applicant: Omnitek Partners LLC, Ronkonkoma, NY (US)

(72) Inventors: Jahangir S. Rastegar, Stony BRook, NY (US); Harbans Dhadwal, Setauket, NY (US)

(73) Assignee: Omnitek Partners LLC, Ronkonkoma, NY (US)

(21) Appl. No.: 19/383,192

(22) Filed: Nov. 7, 2025

Related U.S. Application Data
(60) Provisional application No. 63/717,748, filed on Nov. 7, 2024.

(51) Int. Cl. H01G 2/08; B60L 50/40; B60L 58/24; H01M 10/615; H01M 10/625; H01M 10/637; H02J 7/00

(52) U.S. Cl. CPC H01G 2/08; B60L 58/24; H01M 10/615; H01M 10/625; H01M 10/637; H02J 7/977; B60L 50/40; H01M 2220/20; H02J 2207/50

(57) ABSTRACT

A method including: charging a capacitor in parallel to the ESD; determining whether an energy storage device (ESD) is in use; monitoring temperature of the ESD, the ESD has a prescribed and operational temperature range; discharging the capacitor through an inductor by temporary actuation of a switch that couples the inductor in parallel to the capacitor, wherein oscillation of current and voltage is provided by a first circuit formed by the capacitor and the inductor, maintaining the ESD temperature within temperature range through oscillation of the ions due to high frequency oscillation of a second circuit formed by the capacitor and the internal inductance of the ESD, repeating the temporary reactuation of the switch while temperature is within the temperature range. Wherein the given temperature range is the prescribed temperature range when the ESD is not being used and is the operational temperature range when the ESD is being used.

### BACKGROUND

### 1. Field

The present disclosure relates generally to energy storage devices, such as rechargeable batteries and supercapacitors, more particularly to methods and programmable apparatus for maintaining the batteries of electrically powered vehicles and other fixed or mobile platforms at their optimal charging and operational temperature range.

### 2. Prior Art

Electric powered vehicles are becoming more popular and widespread. Cars are not the only type of vehicles that can be an electric powered vehicle. For example, buses, trucks, lift-trucks, boats, locomotives, airplanes and heavy-duty vehicles are also available as electric powered vehicles.

Electric vehicles are usually powered by an electrical energy storage system. The energy storage system here being defined as any kind of battery, battery pack or series of batteries for powering the electric vehicle.

It is appreciated that for practical reasons, it is important that the electrical energy storage system has a long lifetime, i.e., a large number of charge/discharge cycles be possible before the cells fail to operate satisfactorily. Keeping the electrical energy storage system in an optimal temperature range is essential to maximizing its lifetime.

The performance of batteries and super-capacitors is significantly reduced at low temperatures. This is the case for both primary and rechargeable batteries. In addition, current lithium-ion, Lithium-polymer and other similar battery technology does not allow battery charging at temperatures below zero degrees c. and charging at temperatures below their optimal level has been shown to reduce battery life. In addition, at lower than their optimal temperature range of operation, batteries cannot provide their maximum available power to the system that is being powered.

Electrical energy storage systems which are cold would take a lot of energy and time to heat to the working temperature above the minimum optimal operating range of their batteries. Therefore, it is essential to preheat these electrical energy storage systems using external power sources to ensure that the maximum amount of electrical energy is available for the electrically powered vehicle operation.

Current solutions that try to address cold weather effects on batteries include heating the exterior of the battery by integrating “heaters” into the battery compartment or using heating blankets, or recently by embedding heating elements inside the batteries.

A newly developed method and related devices has the advantage of rapidly and efficiently heating the battery electrolyte directly using appropriately formed high frequency AC currents. The methods and devices take advantage of the electrical characteristics of the batteries and super-capacitors to heat the electrolyte directly and very rapidly to its optimal operating temperature without causing any damage as described in the following U.S. Patents, U.S. Patent Application Publications and U.S. Patent Application, each of which being incorporated herein in their entirety by Reference: 10,063,076; 10,855,085; 11,211,809; 11,211,810; 11,594,908; 12,074,301; 12,354,797; 12,381,044; 12,360,541; 2020/0176998; 2023/0344029; 2023/0359231; 2024-0136616 and Ser. No. 18/244,275.

The high frequency AC current electrolyte heating units may be externally powered, even at very low battery temperatures. However, once the battery is warm enough to provide enough power, the battery temperature may be raised to its optimal level and maintained at that level by power from the battery itself. The battery may be fully charged or discharged as it is heated.

The high frequency AC current electrolyte heating units are inherently highly efficient and safe and can be readily integrated into the battery safety and protection circuitry and battery chargers.

The following are some of the main characteristics of the high frequency AC current electrolyte heating methods and devices:
It requires no modification to the battery.
The basic physics of the process and extensive tests clearly show no damage to the battery and super-capacitor.
The battery pack protection electronic units, such as those for Lithium-ion and Lithium-polymer batteries, can still ensure continuous high-performance operation at low temperatures.
The battery electrolyte is directly and uniformly heated, therefore bringing a very cold battery to its optimal operating temperature very rapidly and minimizing heat loss from the battery.
Direct electrolyte heating requires significantly less electrical energy than external heating such as with the use of heating blankets.
Standard sized Li-ion or Li-polymer batteries can be used instead of thin and flat battery stack packaging to accelerate external heating via heating blankets or the like.
The technology is simple to implement and low-cost.

It is appreciated that it is highly desirable to develop methods and devices that can utilize the above high-frequency direct battery electrolyte technology and provide a single device that could address the above requirements of electric vehicles and various mobile platforms as well as stationary platforms/systems, such as fixed and mobile electrical energy storage units. In addition, it is also highly desirable to have available a single unit that could provide all the above functionalities for optimal operation of electrically powered mobile and fixed platforms, i.e., to provide the following functionalities in below optimal environmental temperature ranges for the platform batteries:
1—Maintain the platform battery temperature within its optimal operational range in colder than optimal environmental conditions while the platform is being operated, i.e., while the platform batteries are partially or fully powering the platform electrical load.
2—Maintain the platform battery temperature within its optimal charging temperature range in colder than optimal environmental conditions while the platform batteries are being charged.
3—While the platform is not in use, maintain the battery temperature above a specified minimum temperature that prevent damage to the battery until the time that the battery temperature must have been brought to within its optimal operational temperature for the platform to begin its service.

In current electrically powered vehicles, in cold environmental conditions, the power for heating the battery while the vehicle is in service, i.e., when external (line) power source is not available, comes from electrical energy storage system, i.e., from the vehicle batteries. Therefore, it is highly desirable that the battery heating process be very efficient, i.e., consume as little of battery stored electrical energy as possible, so that the stored electrical energy of the batteries can be used for the vehicle operation.

In one electric vehicle service scenario, the electric vehicle is parked outside a temperature-controlled structure, such as in an open parking area, long enough for the temperature of the vehicle batteries drops below the level at which the batteries can provide enough power for proper operation of the electric vehicle. It is appreciated that in most such situations, such as, when the electric powered vehicle is parked for relatively short periods of time and away from external power sources, when the environmental temperature is low, the battery temperature could drop below the level that it could provide enough power for the electric vehicle to operate properly.

In addition, in the case of batteries such as Lithium-ion batteries and the like, operation of the battery at below a certain cold temperature would damage the battery and reduce its operational life.

It is also appreciated that a similar situation can also be faced by vehicles powered by internal combustion engine, hybrid vehicles, and the like platforms, in which the vehicle is parked for a certain amount of time, which could even be one hour or even less in very cold environments, which would quickly lower the battery temperature of the vehicle below the temperature that the battery can provide enough power to get the vehicle engine started. Vehicles and various platforms operating in cold environments, such as snow removal or snowmobile, are regularly faced with such situations at very low temperatures.

In another electric vehicle use scenario, the electric vehicle is parked outside a temperature-controlled structure, such as in an open parking area, for a relatively long period of time, for example overnight while the environment temperature is very cold. The battery system of the electric vehicle may or may not be connected to a battery charger. In this scenario, it is highly desirable that the battery temperature be kept above a minimum temperature level to prevent it from being damaged and from staying capable of being charged and/or powering the vehicle. In particular, if the battery is connected to a charger, it is highly desirable that the battery temperature be maintained at its optimal temperature for charging.

In addition, it is also highly desirable that once the batteries of the electric powered vehicle has been charged, the battery temperature be maintained above the level at which the battery could be damaged, while the electric powered vehicle is parked and its temperature is brough up to within the optimal operating temperature of the battery by the time that the electric powered vehicle is to be brough into service.

It is also appreciated that a similar situation can also be faced by vehicles powered by internal combustion engine, hybrid vehicles, and the like platforms, in which the vehicle is parked for a relatively long period of time, such as overnight, which would lower the battery temperature of the vehicle below the temperature at which the battery can provide enough power to get its engine started. Vehicles and various platforms operating in cold environments, such as snow removal or snowmobile, are regularly faced with such situations at very low temperatures. In this scenario, it is highly desirable that the battery temperature be kept above a minimum temperature level to prevent it from being damaged or capable of providing enough power to start the engine and stay within the optimal range of operational temperature when the vehicle is planned to go into service.

In another electric vehicle use scenario, the electric vehicle is in service in a cold environment. When the environmental temperature is low, such as, in very to extremely low temperatures, then the battery temperature could drop to low enough levels at which the battery can no longer provide enough power to the vehicle for its operation and could also cause damage to the battery and shorten its operational life. This can be a problem for Lithium-ion and other similar batteries at even temperatures that are not extremely low. In all such situations, it is highly desirable that the battery temperature be maintained within its optimal operating temperatures using the stored electrical energy in the battery so that the vehicle could continue its service without interruption. It is also appreciated that the method and devices to be used to achieve this goal is highly desirable to be very efficient, i.e., use minimal electrical energy, so that the operational time of the electric powered vehicle is minimally shortened.

It is also appreciated that a similar situation can also be faced by vehicles powered by internal combustion engine, hybrid vehicles, and the like platforms, in which the vehicle is in service in a cold environment, such as, in a very to extremely low temperature. The battery temperature may drop to low enough levels at which the battery no longer can provide enough power to the vehicle or gets damaged or shorten its life or cannot provide enough power to restart the vehicle. This is obviously a more serious issue with Lithium-ion and other similar batteries than Lead-acid batteries at even temperatures that are not very low. In all such situations, it is highly desirable that the battery temperature be maintained within its optimal operating temperatures using the battery stored electrical energy or the vehicle generated electrical energy so that the vehicle could continue its service without interruption and could be restarted after relatively short stops. It is also appreciated that the method and devices to be used to achieve this goal is highly desirable to be very efficient.

It is appreciated by those skilled in the art that similar situations are faced by stationary platforms, such as rechargeable battery-based back-up power sources and electrical energy storage units that are provided with line power (external power sources). In such systems, the temperature of system batteries must still be maintained within an optimal operational range so that they could power the intended systems as the line power (external power) is disrupted and that the batteries are not damaged or charged below their optimal charging temperature range.

It is also appreciated that with current methods, in cold environments, a separate system is required to heat an electrically powered platform power to its optimal operational or charging temperature range, weather using the battery power or an external power source, and a separate system is required maintain the battery the battery temperature within its optimal operating range for electrically powered mobile platforms.

Thus, it is also highly desirable to have a single system that can be readily connected to the platform battery that would serve all above functions, i.e., would heat the battery to its optimal charging temperature as well as maintain the battery temperature within its optimal operational range.

It is also appreciated that the above is also the case for rechargeable batteries, such as Lead-acid batteries, used in vehicles powered by internal combustion engines, hybrid vehicles, and the like, i.e., one system (for example heating pads or blankets), must be used to keep the battery within its appropriate operating range as well as for allowing the battery be charged by the vehicle charger when the platform is in service.

It is also appreciated that it is also highly desirable to have such an integrated system to be programmable by the user for each application and for different aforementioned operational scenarios.

### SUMMARY

It is therefore highly desirable to have methods and apparatus for maintaining electrically powered platform batteries in colder than optimal environmental temperatures within their optimal range while the platform is being operated, i.e., while the platform is being powered by the platform batteries. This can be of very critical importance when the environmental temperature is very or extremely low. Electrically powered platforms may be mobile, such as various vehicles, trucks, buses, lift-trucks, and other similar mobile machinery, or stationery, such as outdoor back-up power sources and electrical energy storage systems.

It is also highly desirable to have methods and apparatus for maintaining platform battery temperature within its optimal charging temperature range in colder than optimal environmental conditions while the platform batteries are being charged.

It is also highly desirable to have methods that can be used to develop a single system that can be readily connected to the platform battery and that would serve all above functions, i.e., would heat the battery to its optimal charging temperature as well as maintain the battery temperature within its optimal operational range.

It is also highly desirable to have such an integrated single system to be programmable by the user for each application and for different operational scenarios with high efficiency, while preventing low temperature induced damage to the battery.

A need therefore exists for methods and apparatus for maintaining electrically powered platform batteries in colder than optimal environmental temperatures within their optimal range while the platform is being operated, i.e., while the platform is being powered by the platform batteries. This can be very critical for electrically powered platforms operating in extremely low temperatures. Electrically powered platforms may be mobile, such as various vehicles, trucks, buses, lift-trucks, and other similar mobile machinery, or stationery, such as outdoor back-up power sources and electrical energy storage systems.

A need also exists for methods and apparatus for maintaining batteries of platforms powered by internal combustion, fuel cell, hybrid vehicles, and the like in colder than optimal environmental temperatures within their optimal range while the platform is being operated, i.e., while the battery power is used by the vehicle and the battery is charged by the vehicle generator, such as in snow removal equipment, snowmobiles, lift-trucks, and other similar platforms. This can be very critical for such platform operating in extremely low temperatures, such as, since they cannot be restarted when the platform battery drops below a certain temperature at which the battery cannot provide the required starting power to the vehicle engine and that the battery could get damaged due to the cold temperature charging and/or operation or due to the cold temperature itself. The platforms may be mobile, such as various vehicles, trucks, buses, lift-trucks, and other similar mobile machinery, or stationery, such as outdoor back-up generators for power sources and electrical energy storage systems.

A need therefore exists for methods and apparatus for maintaining electrically powered platform batteries in colder than optimal environmental temperatures within their optimal charging range while the platform is being charged by an external power source. This can be very critical for electrically powered platforms operating in extremely low temperatures since their batteries can be damaged and their life be significantly reduced. In addition, in many batteries, the charging rate drops significantly with a drop in temperature. Electrically powered platforms may be mobile, such as various vehicles, trucks, buses, lift-trucks, and other similar mobile machinery, or stationery, such as outdoor back-up power sources and electrical energy storage systems.

Accordingly, methods are provided for the development of devices (systems) that are capable of maintaining the temperature of electrically powered platform batteries in colder than optimal environmental temperatures within their optimal range while the platform is being operated, i.e., while the platform is being powered by the platform batteries. This can be very critical for electrically powered platforms operating in extremely low temperatures. Electrically powered platforms may be mobile, such as various vehicles, trucks, buses, lift-trucks, and other similar mobile machinery, or stationery, such as outdoor back-up power sources and electrical energy storage systems.

Accordingly, methods are also provided for the development of devices (systems) for maintaining the temperature of batteries of platforms powered by internal combustion, fuel cell, hybrid vehicles, and the like in colder than optimal environmental temperatures within their optimal range while the platform is being operated, i.e., while the battery power is used by the vehicle and the battery is charged by the vehicle generator, such as in snow removal equipment, snowmobiles, lift-trucks, and other similar platforms. This can be very critical for such platform operating in extremely low temperatures, for example, since they cannot be restarted when the platform battery drops below a certain temperature at which the battery cannot provide the required starting power to the vehicle engine and that the battery could get damaged due to the cold temperature charging and/or operation or due to the cold temperature itself. The platforms may be mobile, such as various vehicles, trucks, buses, lift-trucks, and other similar mobile machinery, or stationery, such as outdoor back-up generators for power sources and electrical energy storage systems.

Accordingly, methods are also provided for the development of devices (systems) for maintaining electrically powered platform batteries in colder than optimal environmental temperatures within their optimal charging range while the platform is being charged by an external power source. This can be very critical for electrically powered platforms operating in extremely low temperatures since their batteries can be damaged and their life be significantly reduced. In addition, in many batteries, the charging rate drops significantly with a drop in temperature. Electrically powered platforms may be mobile, such as various vehicles, trucks, buses, lift-trucks, and other similar mobile machinery, or stationery, such as outdoor back-up power sources and electrical energy storage systems.

Accordingly, methods are also provided for the development of integrated devices (systems) that are programmable by the user for each application and for different operational scenarios, i.e.:
Maintaining the temperature of electrically powered platform batteries in colder than optimal environmental temperatures within their optimal range while the platform is being operated, i.e., while the platform is being powered by the platform batteries.
Maintaining the temperature of batteries of platforms powered by internal combustion, fuel cell, hybrid vehicles, and the like in colder than optimal environmental temperatures within their optimal range while the platform is being operated, i.e., while the battery power is used by the vehicle and the battery is charged by the vehicle generator.
Maintaining electrically powered platform batteries in colder than optimal environmental temperatures within their optimal charging range while the platform is being charged by an external power source.
Maintaining battery temperature of any mobile or stationary platform above the minimum temperature which would prevent battery damage in cold temperatures using either an external power source or the battery power.
Providing programmability capability for the user to set the battery heating and charging schedule while the vehicle (electrically or internal combustion or the like powered) or any other type of platform, including mobile and stationary platforms, is not in service, and when the battery temperature must be within its optimal operational temperature range.

A need also exists for methods that can be used to develop integrated systems that can be readily connected to almost any platform battery and that would serve all above functions, i.e., would heat the battery to its optimal charging temperature as well as maintain the battery temperature within its optimal operational range.

Accordingly, methods are also provided for the development of integrated systems that can be readily connected to almost any platform battery and that would serve all above functions, i.e., would heat the battery to its optimal charging temperature as well as maintain the battery temperature within its optimal operational range.

It is also desirable that the above battery self-heating methods and apparatus for the development of integrated systems that can be readily connected to almost any platform battery and that would serve all above functions, i.e., would heat the battery to its optimal charging temperature as well as maintain the battery temperature within its optimal operational range while the platform is in operation and/or its batteries are being charged, so that the battery temperature would not drop below a predetermined threshold and that the battery stays at or close to its peak performance levels. For this reason, the provided methods must be capable of preventing damage to the powered load electrical and electronic circuits and components. Here, the powered load refers to all the electrical and electronic components and instrumentations of the electrically powered platform, such as an electric vehicle, truck, bus, and other mobile or stationary platforms previously described, including battery charging electronics and electrical components and the battery safety and power management systems, etc.

A need therefore exists for methods and apparatus that can be used to develop integrated systems that can be readily connected to almost any platform battery and that would serve all above functions, i.e., would heat the battery to its optimal charging temperature as well as maintain the battery temperature within its optimal operational range while the platform is in operation and/or its batteries are being charged, so that the battery temperature would not drop below a predetermined threshold and that the battery stays at or close to its peak performance levels. It is appreciated that for this reason, the developed integrated systems based on these methods must be capable of preventing damage to the powered load electrical and electronic circuits and components. Here, the powered load refers to all the electrical and electronic components and instrumentations of the electrically powered platform, such as an electric vehicle, truck, bus, and other mobile or stationary platforms previously described, including battery charging electronics and electrical components and the battery safety and power management systems, etc.

Accordingly, methods are also provided for the development of integrated systems that can be readily connected to almost any platform battery and that would serve all above functions, i.e., would heat the battery to its optimal charging temperature as well as maintain the battery temperature within its optimal operational range while the platform is in operation and/or its batteries are being charged, so that the battery temperature would not drop below a predetermined threshold and that the battery stays at or close to its peak performance levels. The powered load refers to all the electrical and electronic components and instrumentations of the electrically powered platform, such as an electric vehicle, truck, bus, and other mobile or stationary platforms previously described, including battery charging electronics and electrical components and the battery safety and power management systems, etc.

### BRIEF DESCRIPTION OF THE DRAWINGS

These and other features, aspects, and advantages of the apparatus will become better understood with regard to the following description, appended claims, and accompanying drawings where:

FIG. 1 illustrates an equivalent (lumped) circuit model of a battery that is subjected to a high-frequency AC current.

FIG. 2 illustrates an equivalent circuit model of a battery for high frequency heating at a given battery temperature.

FIG. 3 illustrates the plot of the amplitude of the applied test AC voltage at the battery terminals as a function of frequency.

FIG. 4 illustrates the plot of the amplitude of the applied test AC current at the battery terminals as a function of frequency.

FIG. 5 illustrates the plot of the amplitude ration of the voltage and current as a function of frequency.

FIG. 6 illustrates the plot of the phase angle (leading) between the voltage and current waveforms of FIGS. 3 and 4, respectively.

FIG. 7 illustrates the plot of heating rate at room temperature for the tested CR123A Li-ion battery as a function of heating current frequency with a fixed RMS current of 4 A.

FIG. 8 illustrates the plot of heating curves for the CR123 Li-ion battery by externally supplied power at 80 KHz at various AC current amplitudes.

FIG. 9 illustrates the plot of heating rate of the CR123 Li-ion battery with 80 kHz current of different amplitudes as measured and as predicted by the developed model, equation (11).

FIG. 10 illustrates the schematic of an exemplary high-frequency current battery heating circuit that is powered by an external power source.

FIG. 11 illustrates the block diagram of a “Battery-Powered High-Frequency Battery Heater” connection to the battery and the electrical/electronic system of a battery powered mobile or stationary platform.

FIG. 12 illustrates the block diagram of the platform battery of the embodiment of FIG. 11 being connected to a battery charger for charging.

FIG. 13 illustrates the circuit schematic of the “Battery-Powered High-Frequency Battery Heater” embodiment as connected to powering battery for its heating.

FIG. 13A illustrates the modified circuit schematic of the “Battery-Powered High-Frequency Battery Heater” embodiment of FIG. 13 to allow adjustment of the frequency of the high-frequency battery heating current.

FIG. 14 illustrates the sequence of signals that are generated for the operation of the “Battery-Powered High-Frequency Battery Heater” embodiment of FIG. 13.

FIG. 15 illustrates current and voltage plots of the “Battery-Powered High-Frequency Battery Heater” embodiment during the battery heating.

FIG. 16 illustrates current and voltage waveform in the LC circuit of the “Battery-Powered High-Frequency Battery Heater” embodiment of FIG. 13.

FIG. 17 illustrates the battery heating high-frequency current and voltage waveform that is passing through the battery for its heating.

FIG. 18 illustrates the method of achieving higher heating rate from the “Battery-Powered High-Frequency Battery Heater” embodiment of FIG. 13 by adjusting the heating pulse repetition rate.

FIG. 19 illustrates the method of connecting the “Battery-Powered High-Frequency Battery Heater” embodiments of FIGS. 13 and 13A to an electrically powered load (electrically powered mobile or stationary platform) to maintain the battery temperature within a prescribed temperature range via a provided low-pass filter to eliminate the high-frequency heating current from interfering with the load electrical and electronic operation.

FIG. 20 illustrates the method of connecting the “Battery-Powered High-Frequency Battery Heater” embodiments of FIGS. 13 and 13A in parallel to a charger being used to charge the platform battery to maintain the battery temperature within a prescribed range via a provided low-pass filter to eliminate the high-frequency heating current from interfering with the operation of the charger.

FIG. 21 illustrates the method of connecting the “Battery-Powered High-Frequency Battery Heater” embodiments of FIGS. 13 and 13A and a charger to a fully or partially electrically powered load to maintain the battery temperature within a prescribed temperature range via a provided low-pass filter to eliminate the high-frequency heating current from interfering with the load and charger electrical and electronic operation.

FIG. 22 illustrates the method and device design for connecting and disconnecting a battery charger to a “Battery-Powered High-Frequency Battery Heater” equipped electrically powered platform with integrated high-frequency heating current low-pass filter to avoid any interference with the operation of the charger and load electrical and electronic circuits and components.

FIG. 23 illustrates the block diagram of a “Battery-Powered High-Frequency Battery Heater” connection to the battery and the electrical/electronic system of a battery powered mobile or stationary platform and a battery charger.

### DETAILED DESCRIPTION

The only currently available technology for heating batteries in cold temperature environments so that they can be charged without battery damage and be conditioned to effectively provide their stored energy and current to power various battery-operated devices in cold environments are: (1) “self-internal heating”, in which the hattery is heated through internal resistance of the battery. The so-called “mutual pulse heating” is also in this category since it also heats the battery through its internal resistance, even though the heating current is supplied by the paired batteries; (2) heating batteries by externally generated heat, such as by heating pads or heating blankets, or convective heating by blowing heated air through the battery pack or the like; (3) heating batteries via internally provided electrical heating members, which are powered by either external sources or by the battery power.

The above basic categories of battery heating methods have shortcomings that make them impractical and/or undesirable for a wide range of systems and devices for operation in cold environments, in particular operation in extreme cold environments. It is appreciated that even 5-10 degrees C. below the optimal charging and operational temperature of batteries would also affect the life and the level of power that batteries can provide, such as, for Lithium-ion and other similar types of batteries.

These shortcomings may be described briefly as follows:

1) Self-Internal Heating: In these methods, the battery is heated through internal resistance of the battery. In operation in cold and for example, in extreme cold environments, even when the load is using the maximum available current, the amount of generated heat is not enough to keep the battery warm, and its temperature would rapidly drop as the battery temperature drops followed by available current drop in a viscous cycle that would quickly lead to the lack of enough current to power the intended device. The only general option for heating through internal resistance would then be the use of the so-called “mutual pulse heating”, which for the very cold and extreme cold environment operation would require the application of very high (effectively DC) currents (using DC-DC converters) through the battery, which would damage the battery.

### 2) Heating by Externally Generated Heat:

In this method, heat is generated by externally positioned heating elements such as resistive heating coils, and used to heat the battery through conduction, for example by heating pads or blankets, or through convection, by blowing a hot medium such as air over the batteries. The power to generate heat may be from external sources or from the battery itself. Heat conduction inside the battery pack becomes the limiting factor due to the thickness of the battery cell and the insulating nature of the outer battery layers. This leads to a large temperature gradient inside the battery. As a result, these heating methods are not energy efficient and have slow heating rate. In addition, the heating pads and blankets and other heating components significantly increase the total occupied power source volume, and thereby also the amount of energy needed to keep the battery warm and compensate for the increased heat loss through the increased outside surfaces of the power source. In short, these methods are impractical and undesirable for a wide range of systems and device powering for cold environments, such as, for extreme cold environments.

### 3) Heating by Internally Provided Electrical Heating Members:

This method heats up the battery, by Joule heating, through the addition of internally provided electrical resistance heating elements within the battery. The heating power may be supplied by external sources or some of the internal battery power may be diverted through the resistance elements. However, for rapid heating rates that are required for operation in very cold environments, high current heating rates are required, which would create high overpotential. Therefore, heating during the charging step should be avoided to prevent plating of Lithium metal. Large temperature gradients and hot spots are possible, which can cause high temperature electrolyte degradation, off-gassing, and ultimately fire and explosion hazards.

The recently developed typical battery model that represents the dynamic behavior of its electrolyte when subjected to high-frequency AC current is herein presented and the basic physics of this behavior is briefly described. Actual tests performed to validate the developed model, and the method used to determine the parameters of the model for a selected small Lithium-ion battery are also briefly described. The model and the disclosed method to determine its parameters is general and valid for all primary, rechargeable, as well as reserve batteries such as liquid reserve and thermal reserve batteries widely used in munitions. Actual test results of the selected Lithium-ion battery heating at temperatures as low as −58° C. is also presented. The results of self-heating tests for keeping battery core temperature at room temperature in a −60° C. environment is also provided.

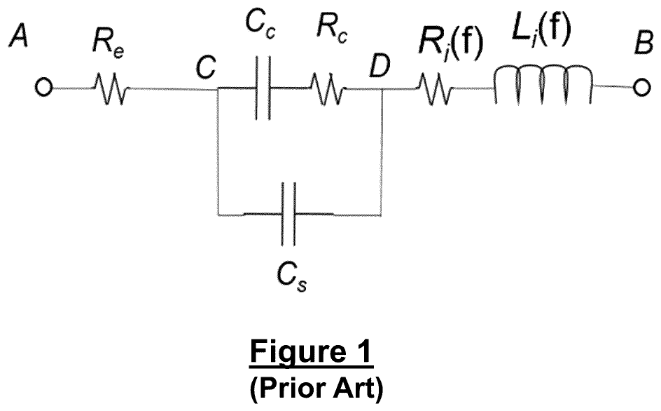

The basic operation of any battery may be approximately modeled with the equivalent (lumped) circuit shown in FIG. 1. In the following discussion on battery heating, electrical circuit elements and terminology is utilized for convenience to demonstrate their approximated physical behavior in a battery. The temperature and frequency dependance of the elements used to model the battery electrolyte component of the battery can be very critical to the development of the high-frequency AC current heating technology and is therefore the focus of the studies being presented.

In the model of FIG. 1, the resistor Rₑ represents the electrical resistance against electrons from freely moving in conductive materials with which the electrodes and wiring are fabricated. The equivalent resistor Rᵢ(f) and Lᵢ(f) represent the temperature and frequency (f) dependent resistance to free movement of ions and their resistance to acceleration due to their mass, ion-ion and ion-electrode surface interactions, etc., respectively. The capacitor Cₛ is the surface capacitance, which can store electric field energy between electrodes, acting like parallel plates of capacitors. The resistor R_{c} and capacitor C_{c} represent the electrical-chemical mechanism of the battery in which C_{c} is intended to indicate the electrical energy that is stored as chemical energy during the battery charging and that can be discharged back as electrical energy during the battery discharging, and R_{c} indicates the equivalent resistance to discharging current. The terminals A and B indicate the terminals of the battery.

The operation of a battery, such as a Li-ion battery used here as an example, as modeled in FIG. 1, may then be described as follows. If an AC current with high enough frequency is applied to the battery, due to the low impedance of the capacitor Cₛ, there will be no significant voltage drop across the capacitor, i.e., between the junctions C and D, and the circuit effectively behaves as if the capacitor Cₛ were shorted. As a result, the applied high-frequency AC current essentially passes through the resistors Rₑ and Rᵢ and inductor Lᵢ and not through the R_{c} and C_{c} branch to damage the electrical-chemical components of the battery. Any residual current passing through the R_{c} and C_{c} branch would not damage the battery due to its high-frequency and zero DC component.

The resistance Rₑ is very small in batteries and would generate negligible amount of heat. However, at any given temperature, the frequency dependent Rᵢ(f), which is shown later to increase rapidly with increased frequency of the applied current, would generate heat in the battery electrolyte at a rate that is proportional to the square of the applied RMS current. This technology relies on this process for direct heating of a battery electrolyte at a very high rate without causing any damage to the battery. It is also noted that since the electrical-chemical components of the battery are effectively bypassed, the applied high AC current and related voltage can be higher than those rated for the battery without causing any damage. The temperature and frequency dependent Lᵢ cause a phase shift between the applied high-frequency current and voltage to the battery, which due to the nonlinear nature of the electrolyte behavior, cannot provide information about the power loss inside the battery (battery heating).

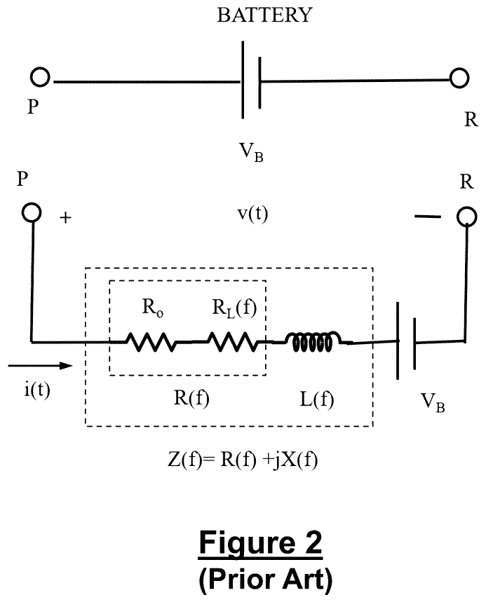

Based on the above discussion of high frequency heating, a first order electric circuit model must include a frequency dependent heating element as well as an inductive component accounting for the phase shift between the driving AC voltage applied between the battery terminals and the AC current flowing in the electrolyte. One such electric circuit model is illustrated in FIG. 2.

The model of FIG. 2 includes a non-frequency dependent resistor Rₒ, and a frequency dependent inductive reactance X(f) and a frequency dependent resistor R(f). The battery impedance Z(f) is therefore given by

$$Z ( f ) = R ( f ) + jX ( f ) \qquad ( 1 )$$

Using the first order approximation, R(f) and X(f) can be expressed as,

$$R ( f ) = [ P 0 + P 1 f ] and X ( f ) = P 2 f \qquad ( 2 )$$

where f is the frequency in Hz, P0 is the resistance in mΩ at f=0 and P1 and P2 are constant coefficients with units, which are determined by fitting to the experimentally measured frequency scan data for the battery of interest described below.

The voltage v(t) and the current i(t) at the battery terminals, FIG. 2, are given by

$$v ( t ) = {V}_{o} cos ( 2 π f t + {θ}_{v} ) and i ( t ) = {I}_{o} cos ( 2 π f t + {θ}_{i} ) \qquad ( 3 )$$

where Vₒ and θᵥ are the amplitude and phase angle of the voltage and Iₒ and θᵢ are the amplitude and phase angle of the current waves, respectively. The DC voltage term corresponding to the battery voltage is excluded from the equation. Using phasor notation, the battery “impedance” Z(f) is expressed in terms of its magnitude and phase.

$$\vert Z ( f ) \vert = \sqrt{{R}^{2} ( f ) + {X}^{2} ( f )} = \sqrt{{( {P}_{0} + {P}_{1} f )}^{2} + {( {P}_{2} f )}^{2}} \qquad ( 4 )$$

$$Φ ( f ) [ deg ] = \frac{180}{π} {tan}^{- 1} [ \frac{X ( f )}{R ( f )} ] = \frac{180}{π} {tan}^{- 1} [ \frac{{P}_{2} f}{( {P}_{0} + {P}_{1} f )} ] \qquad ( 5 )$$

Either equation (4) or equation (5) can be used to obtain the unknown coefficients P0, P1 and P2, through a non-linear least squares curve fitting technique. Alternatively, equation (2) for R(f) and X(f) can also be used to obtain the unknown parameters. The process of obtaining these parameters for any battery at a given battery temperature is described below.

While heating at a given battery temperature, the RMS current I, flowing through the frequency dependent “resistor” R(f) of the battery generates heat due to the absorbed power I²R(f). It should be noted that R(f) is fictitious and is used to describe the first order heating effect due to the oscillatory motion of the ions in the electrolyte and the electrolyte medium resistance to the motions, and interactions between the ions and between the ions and the electrode surfaces. The absorbed power, indicated as P(f, I), can then be expressed as

$$P ( f , I ) = {I}^{2} R ( f ) = {I}^{2} [ {P}_{0} + {P}_{1} f ] \times {10}^{- 3} [ W ] \qquad ( 6 )$$

where R(f)=(P0+P1 f) and the unknown coefficients P0 and P1 are to be determined for any given battery.

This absorbed power in the battery raises the temperature of the battery electrolyte and based on its mass m (kg), specific heat capacity Cₚ (J·kg⁻¹·° C.⁻¹) and duration t (s). Assuming no heat loss from the battery to the environment, the increase in the equilibrium battery temperature ΔT (° C.) is thereby given by

$$Δ T = \frac{P ( f , I ) t}{{C}_{p} m} \qquad ( 7 )$$

By defining a battery dependent parameter

$$β = m {C}_{p} \qquad ( 8 )$$

the heating rate HR (° C./s) can be obtained by combining equations (6), (7) and (8) as

$$H R ( f , I ) = \frac{Δ T}{t} = \frac{1}{β} {I}^{2} [ {P}_{o} + {P}_{1} f ] [ ° C . / s ] \qquad ( 9 )$$

The high-frequency circuit model for battery heating of FIG. 2 and the derived heating rate equation (9) were validated as described below using a Lithium-ion battery model RCR123A. This is a 3.7 V (800 mAh) cylindrical cell, which is 17 mm in diameter and 34.5 mm in length.

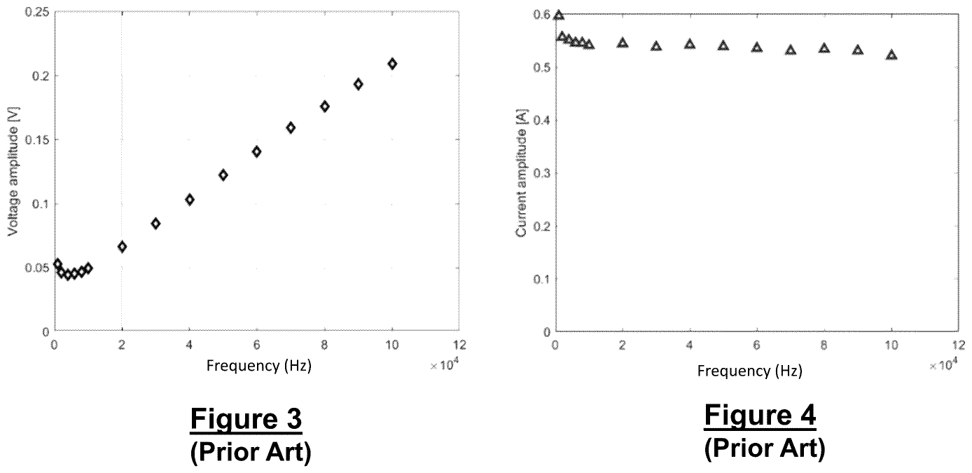

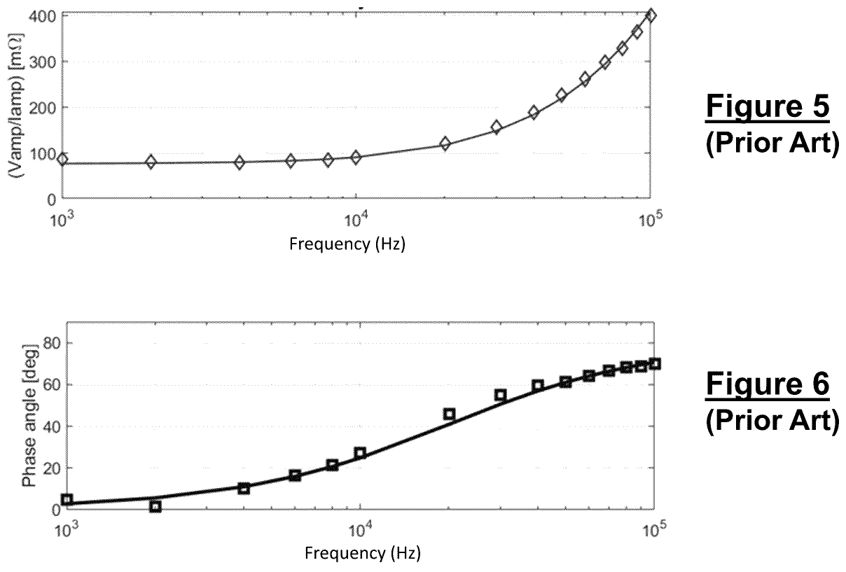

The frequency response of the above test battery at room temperature (20° C.) was characterized over a range of frequencies from 1 kHz to 100 kHz by driving the battery with a low amplitude AC sinusoidal current signal. Both the applied AC current and the corresponding AC voltage were measured at the applied frequency. The voltage and current data from the entire frequency scan was processed to extract the ratio of the voltage to current amplitudes and the phase shift between the voltage and current waveforms. FIGS. 3 and 4 show the measured voltage and current amplitudes across the above frequency sweep, respectively.

The voltage and current data of the plots of FIGS. 3 and 4 are then combined to extract the amplitude ratio of the voltage and current, which is plotted in FIG. 5. The phase angle (leading) between the voltage and current waveforms of FIG. 6 was extracted directly from voltage and current waveforms.

As can be seen in the plots of FIGS. 5 and 6, as the frequency is increased, the phase shift is increased and approaches 90 degrees, which means that the battery is exhibiting the characteristics of an equivalent non-ideal inductive element. This is exactly the behavior predicted by equations (4) and (5), which include an equivalent frequency dependent heating element R(f) and an ideal reactive inductance X(f) (=2πfL).

The data in FIGS. 5 and 6 is then combined to extract data of the corresponding R(f) and X(f). Using the corresponding models expressed in equation (2), unknown model coefficients P₀ and P₁ are extracted by fitting to R(f) data and coefficient P₂ is obtained by fitting to X(f) data. Subsequently, the unknown coefficients are found to be P₀=77.5 mΩ, P₁=5.863×10⁻⁴ mΩ/Hz and P₂=3.9×10⁻³ mΩ/Hz for the tested battery. The solid lines in FIGS. 5 and 6 show the fitted curves obtained using these parameters in equations (4) and (5). It is appreciated that the above parameters are for the battery at room temperature.

At a given temperature, the frequency and current dependent heat rate equation (9) is then obtained for the tested RCR123 Li-ion battery by using the above model coefficients, combined with the knowledge of the physical characteristics of the tested battery. In the case of the tested RCR123A Li-ion, the mass m=0.018 kg and the specific heat capacity is Cₚ=800 J/(kg° C.). Using these values, the battery dependent parameter β, equation (8), becomes

$$β = m {C}_{p} = ( 0.0 \; 18 kg ) ( 800 {Jkg}^{- 1} . ° C {.}^{- 1} ) = 14.4 J . ° C {.}^{- 1} \qquad ( 10 )$$

It should be noted that the value Cₚ is an approximation, based on range of values (700 to 900) found in the literature. Now substituting the values of P₀, P₁ and β into equation (9), the heating rate for the tested battery (RCR123) at room temperature is given as

$$HR ( f , I ) = 6.95 \times {10}^{- 5} [ 77.5 + 0 \text{.586} \times {10}^{- 3} f ] {I}^{2} ° C . / s \qquad ( 11 )$$

where f is in Hz and I is the RMS current in A.

The experimental data below was acquired using the following facilities and equipment. All low temperatures tests were performed in the Test Equity Temperature Chamber Model #115A, AC battery current was measured using a Rogowski current probe (PEMUK CWT/15/B), and AC battery voltage was measured using a Keysight differential voltage probe (#N2791A). Battery temperature was measured using a J-Type thermocouple (#SRTC-TT-K-20-36) and the temperature profile recorded using a DigiSense logger (#20250-03). As it was not possible to mount a thermocouple inside the test battery (RCR123A), it was mounted on the outer surface of the battery, midway along its length and insulated from the ambient convection heat transfer with a 3 mm thick patch of Fiber Frax 3 mm sheet (produced by Unifrax Corporation).

The heating rate equation (11) is validated by performing measurements on Lithium-ion test battery RCR123A, which has a voltage of 3.7 V and capacity of 800 mAh. Other battery heating tests below are also performed with the same type of battery.

At a given battery temperature, the heating rate equation (11) is proportional to both the square of the RMS value and the frequency of the AC heating current. These two dependencies were evaluated independently as described below.

To verify the frequency dependence of the heating rate as described by equation (11), measurements are performed on one of the RCR123A batteries placed in the open room environment. AC heating current over a range of frequencies from 1 kHz to 100 kHz was injected into the battery at an RMS amplitude of 4 A at all frequencies. The battery temperature was measured before and after injecting the AC heating current for 90 s. The heating rate HR (° C./min) was obtained from the temperature difference at the start and end of the heating duration.

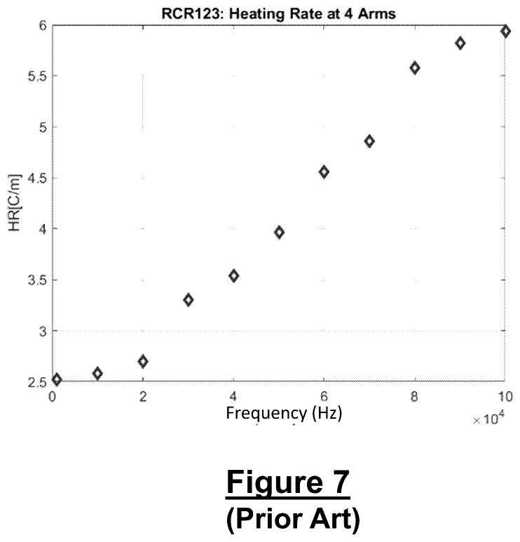

FIG. 7 shows a plot of the heating rate at room temperature of a RCR123A Lithium-ion battery as a function of the AC heating current frequency at a constant RMS value of 4 A.

FIG. 7 confirms that the heat generated by high-frequency AC currents in the battery electrolyte increases rapidly with increasing frequency. The heat generated due to the ion-ion, ion and electrode surfaces, and ion and electrolyte medium interactions, is a non-linear phenomenon, which reaches a peak value at some high frequency, and beyond that frequency the heat generation is seen to begin to decrease. This phenomenon has not been studied in electrolytes and is expected to be primarily due to the resulting oscillatory motion of the ions in the electrolyte medium at high frequencies. The presence of a heating rate peak frequency is also shown in Lead-acid heating rate measurements as a function of frequency presented later in this disclosure.

For the tested RCR123 Li-ion batteries, this optimal heating frequency was around 80 kHz, whereas the measurements with 12 V Lead-acid batteries show an optimal heating frequency of ˜40 kHz.

The measured heating rate is close to 3.9° C./min, which is close to the estimated heating rate of around 5° C./min (7° C./min minus the measured heat loss rate of 2° C./min).

The following tests have also been performed to validate the developed heating rate model. For these tests, the battery was wrapped in a Fiber Frax 3 mm sheet insulation and placed in an insulated box and placed in the environment test chamber. This testing arrangement minimized heat loss from the battery during heating. The heating rate tests were then performed at a frequency of 80 kHz and at four different RMS AC current levels.

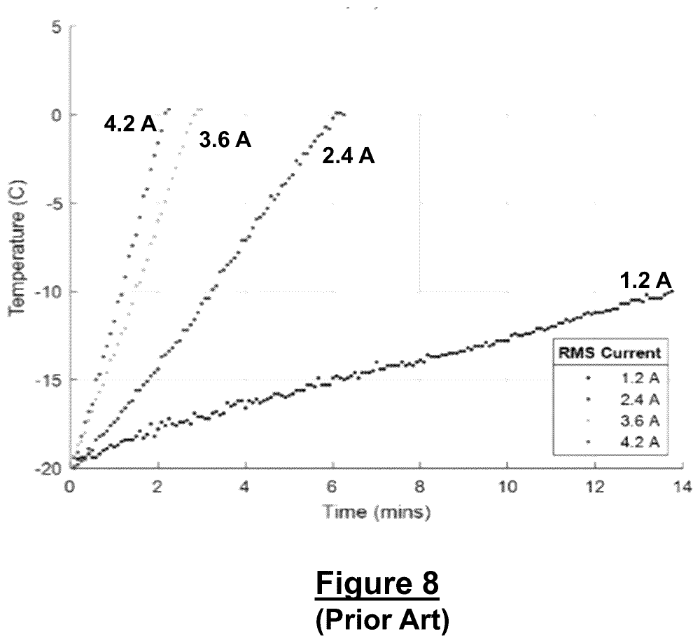

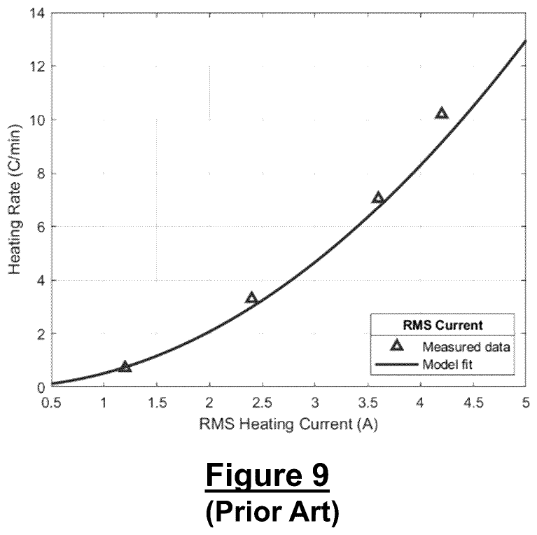

For each current level, the environment temperature was set to −20° C. and soaked for over four hours and the battery was then heated by the indicated applied high-frequency AC current until the battery temperature reached 0° C. As the heating rate is nearly constant over the temperature of 0° C. to 20° C., the model parameters measured at room temperature were used for the model validation purposes. FIG. 8 shows the temperature profiles of the battery electrolyte temperature as a function of time for the four AC current amplitudes. The heating rates were calculated from the nearly linear heating profiles of FIG. 8.

The heating rate data (symbols) as well as the heating rate calculated from the model (solid line), equation (11), are shown in the plot of FIG. 9. The measured data (symbols) is observed to show very good agreement with the predicted (solid line) heating rate described by equation (11).

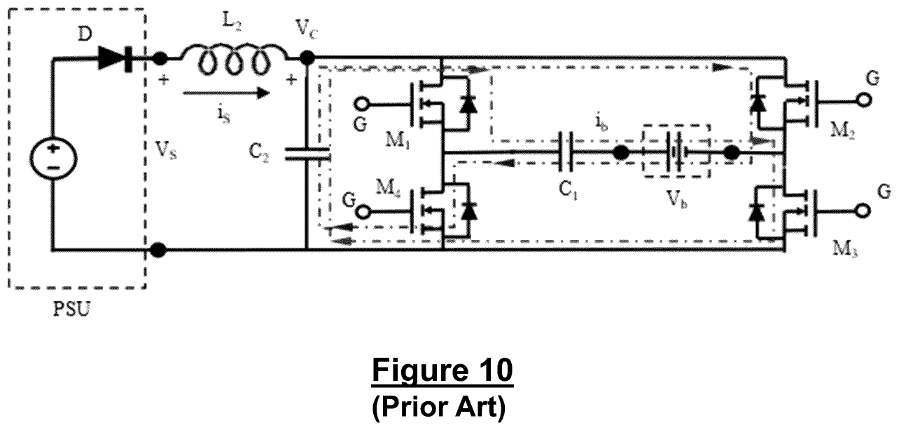

Several high-frequency battery electrolyte heating circuits that are powered by external power sources are described in the U.S. Patents, U.S. Patent Application Publications and U.S. Patent Application mentioned above and incorporated herein by reference. FIG. 10 shows one such high-frequency heating circuit which uses an external single polarity DC power source. The circuit has been used for heating the present single cell RCR123A 3.7 V (800 mAh) Li-ion batteries as well as 36 V (850 Ah) Lead-acid batteries weighing 928 kg. It is noted that as it is described below, the high-frequency current being passed through the battery for electrolyte heating is symmetric, i.e., it has no net DC component.

The flow of oscillatory high-frequency heating currents, indicated by the dash-dot lines, are controlled by the conduction of MOSFET switches M1, M3 and M2, M4. Switching waveforms for the two banks of MOSFETs are generated by a microcontroller. The heating frequency is determined by the resonant frequency of the series RLC which is formed by the DC blocking capacitance C₁ and the combined inductance of the battery and the external components and connecting wires. The MOSFETs are switched OFF/ON at the zero crossings of the high frequency AC battery current. This approach minimizes the switching losses, increasing the efficiency of the heating circuit. Further improvements in circuit efficiency are attained by using a parallel array of low ESR AC coupling capacitors. Diode D prevents current flow back into the DC source, while inductor L₂ provides a soft start. The DC link capacitor C₂ is appropriately sized to meet the peak current demand of the high frequency heating circuit.

As it was previously indicated, it is highly desirable to develop methods and devices that can utilize the above high-frequency direct battery electrolyte technology and provide a single device that could address the requirement of maintaining a platform battery temperature within its optimal operational range in colder than optimal environmental temperature conditions while the platform is being operated, i.e., while the platform batteries are partially or fully powering the platform electrical load.

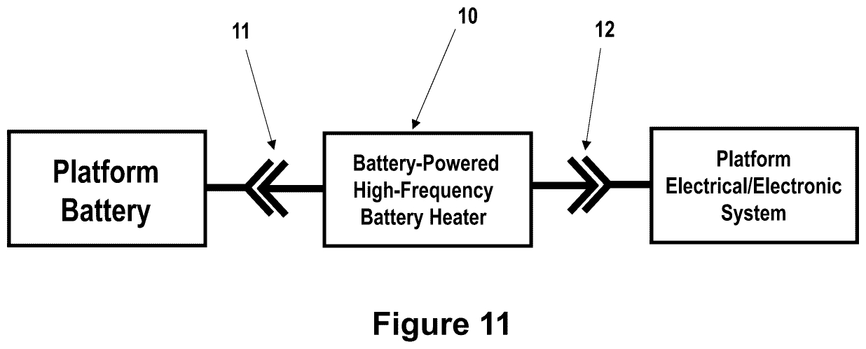

In one embodiment, such a method is used to develop a device, hereinafter referred to as a “Battery-Powered High-Frequency Battery Heater”, FIG. 11, that connected to the “Platform Battery” via a multi-wire connector 11 and to the “Platform Electrical/Electronic System” via a multi-wire connector 12. Here, the “Platform Electrical/Electronic System” refers to all the electrical and electronic components of the platform that are powered by the “Platform Battery”. The detailed circuit design and operation of the “Battery-Powered High-Frequency Battery Heater” is described later in the present disclosure.

It is appreciated that the “Battery-Powered High-Frequency Battery Heater” of FIG. 11 is intended to be applicable to both applications in which the platform batteries are partially or fully powering the platform electrical load. Here, applications in which the battery is fully powering the platform load include electrically powered vehicles, trucks, lift-trucks, or the like mobile platforms, or stationary platforms, such as back-up power sources or electrical energy storage systems and the like.

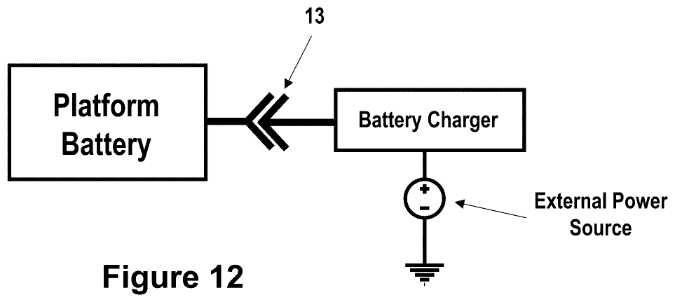

It is appreciated that in FIG. 11, the “Battery-Powered High-Frequency Battery Heater” is shown to be used in applications in which the platform is fully powered by the “Platform Battery”, such as electrically powered vehicles, trucks, lift-trucks, or the like mobile or stationary platforms. In which case, to charge the “Platform Battery”, it is generally disconnected at the connector 11, and connected to the charger connector, indicated as connector 13 in FIG. 12. The batteries of hybrid vehicles, i.e., vehicles that are powered by battery power and/or an internal combustion engine or the like, which are charged by external power, are similarly connected to a charger that is powered by an external power source.

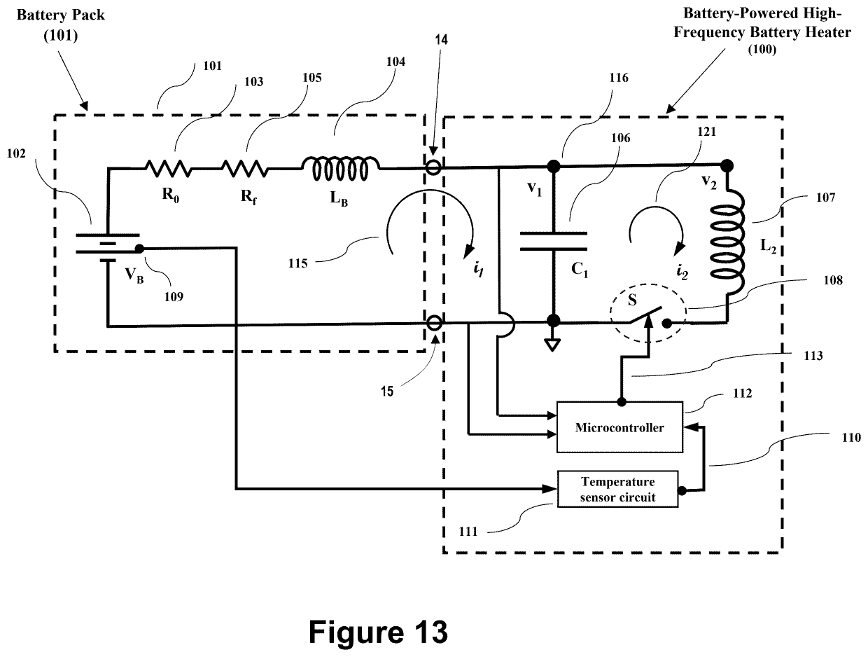

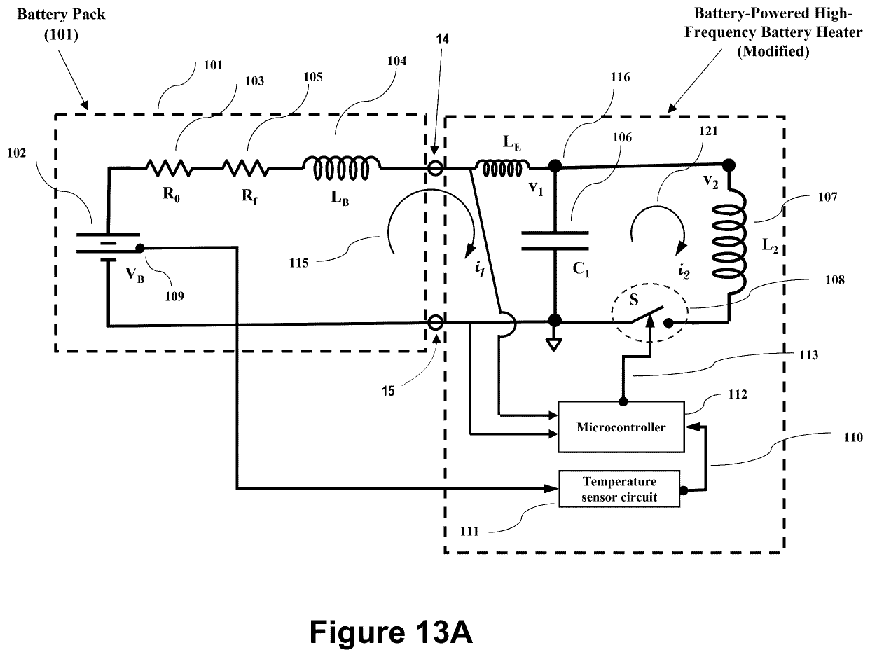

FIG. 13 shows the circuit schematic of the “Battery-Powered High-Frequency Battery Heater” embodiment 100 together with the powering battery (battery pack 101). Here, the “Battery-Powered High-Frequency Battery Heater” embodiment 100 is connected to the battery pack 101 for maintaining the battery core temperature at a prescribed temperature in cold environments. It is appreciated that in the circuit schematic of FIG. 13, the battery pack 101 is not shown to be powering an electrical/electronic load, such as powering an electrically powered mobile or stationary platform.

It is appreciated that in general, the prescribed temperature is the optimal operational temperature of the battery pack 101 in cold environments as measured by a temperature sensor 109 while the platform is in service, for example, while an electrically powered mobile platform such as a vehicle, truck, lift-truck, snow mobile, and the like is being operated. However, the prescribed temperature in cold environments is usually set lower than the above operational temperature of the battery to save electric energy of the battery while the platform is not being used, for example, while the electrically powered mobile platform is parked for a while in between service.

As can be seen in the circuit schematic of FIG. 13, the battery 101 is modeled as an ideal voltage source 102, with an open circuit voltage VB, an internal resistance 103 (R₀), an internal inductance 104 (L_{B}), and a frequency dependent resistance 105 (R_{f}), which is not a physical component, but an equivalent electric circuit resistance component representing the heating produced inside the electrolyte due to the high frequency current, together indicated as the battery pack 101. The “Battery-Powered High-Frequency Battery Heater” 100, also hereinafter referred to as the “Self-Heating Circuit”, circuit comprises of a capacitor 106 (C₁), an inductor 107 (L₂) and an electronic switch 108 (S). The “Battery-Powered High-Frequency Battery Heater” 100 is interconnected with the battery pack 101 at junctions 14 and 15 as illustrated in the circuit schematic of FIG. 13.

The core temperature of the battery is measured by a temperature sensor 109 placed either inside the electrolyte if possible, such as for many Lead-acid batteries, or within the space between the cells or other appropriate location. It is appreciated that for most Lithium-ion and other similar single cell batteries or when there is no access to the inside of the battery pack, the temperature sensor 109 can only be attached to the outer surface of the battery (battery pack), but the sensor has to be well insulated from the environmental temperature and can be calibrated so that it would provide a good estimate of the battery core temperature rather than indicating primarily the environmental temperature within which the battery is positioned.

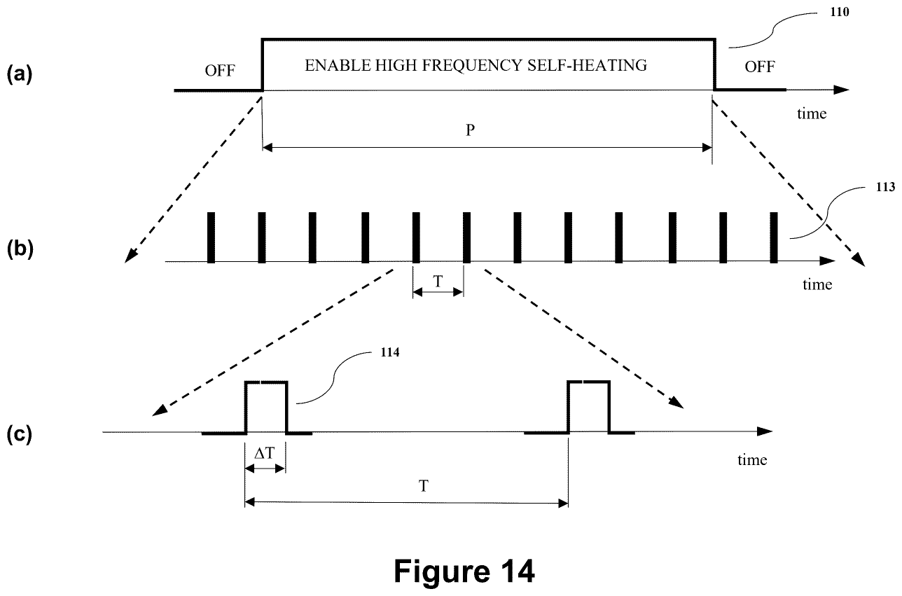

The “Battery-Powered High-Frequency Battery Heater” 100 is initiated by the provided “Microcontroller” 112 when the battery temperature falls below a lower set limit and ceases when the battery temperature rises above the higher set limit. The heating circuit signal 110, FIG. 14(a), is generated by the provided temperature sensor circuit 111. The microcontroller 112 is generally programmed to monitor the battery temperature as provided by the temperature sensor circuit 111 and initiate the battery heating process when the lower battery set temperature is reached or end the battery heating process when the upper battery set temperature is reached. Otherwise, the temperature sensor circuit 111 may be designed to act as a limit switch to signal to the microcontroller 112 to initiate or end battery heating process. The microcontroller 112 is powered by the battery pack 101.

Then when the battery temperature as measured by the sensor 109 drops below the lower battery set temperature, the microcontroller 112 executes a stored program to generate a sequence of periodic timing signals 113, illustrated in FIG. 14(b), to drive the electronic switch 108 of the “Battery-Powered High-Frequency Battery Heater” 100 as described below.

The switching signal 114, illustrated in FIG. 14(c), closes the switch 108 for a short time ΔT. The period T of the timing signal 113 and the switching duration ΔT control the root-mean-square (RMS) magnitude of the high-frequency heating current 115, FIG. 13. The frequency of the high-frequency heating current is a function of the battery inductance 104, and any other inductances due to cables etc., and the external capacitor 106.

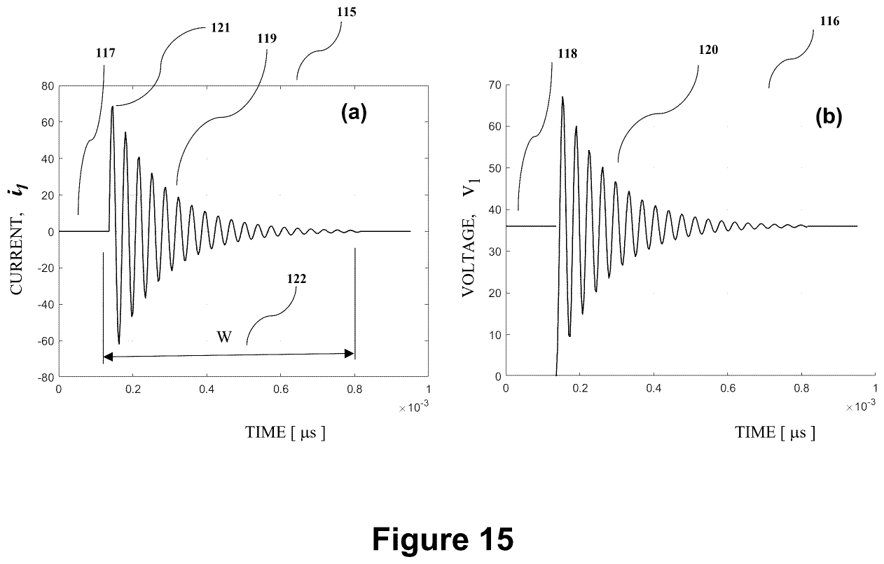

Operation of the “Battery-Powered High-Frequency Battery Heater” 100 is now described with reference to the current 115 (i₁), FIG. 13, voltage 116 (v₁), FIG. 13, waveforms illustrated in FIGS. 15(a) and 15(b), respectively. At the start of the heating cycle, electronic switch 108 is open and the circuit is in steady state, indicated by zero current flow 117 and capacitor voltage v₁ equal to the battery voltage 118, FIGS. 15(a) and 15(b), respectively. These exemplary waveforms are generated assuming a 36V lead-acid battery typically used in lift trucks. Upon demand for battery heating, electronic switch 108 is closed for a brief duration ΔT to rapidly transfer energy from capacitor 106 to inductor 107 and back to capacitor 106. This momentary switching action causes a damped oscillatory current 119 to flow through the battery with a corresponding oscillatory voltage 120 across capacitor 106 as shown in FIGS. 15(a) and 15(b), respectively. The oscillation continues until capacitor 106 reaches steady state and the battery current 115 is zero. During oscillatory current flow, heat is generated in the internal resistance 103 due to ohmic losses. However, significantly more heat is generated inside the battery electrolyte due to the previously described frequency dependent “resistor” R_{f}, FIG. 13, due to the oscillatory motion of the electrolyte ions inside the electrolyte and interactions between the ions and between the ions and the surrounding surfaces. This component of heat generation inside the electrolyte is proportional to the applied frequency. The waveforms in FIG. 15 are generated with a battery voltage of 36V, internal resistance 103 equal to 14.5 mΩ, frequency dependent “resistor” 105 equal to 21.4 mΩ and inductance 104 equal to 2.5 ρH. These parameters give a heating frequency of 30 kHz and a peak heating current 120 of 70A, FIG. 15. In this example, the duration 122 of the damped oscillatory current 119 is approximately 650 ρs and is determined by the ratio of the total resistance to the total inductance of the series RLC circuit. These oscillatory current waveforms are generated periodically 113, FIG. 14(b) to obtain the required increase in the battery temperature.

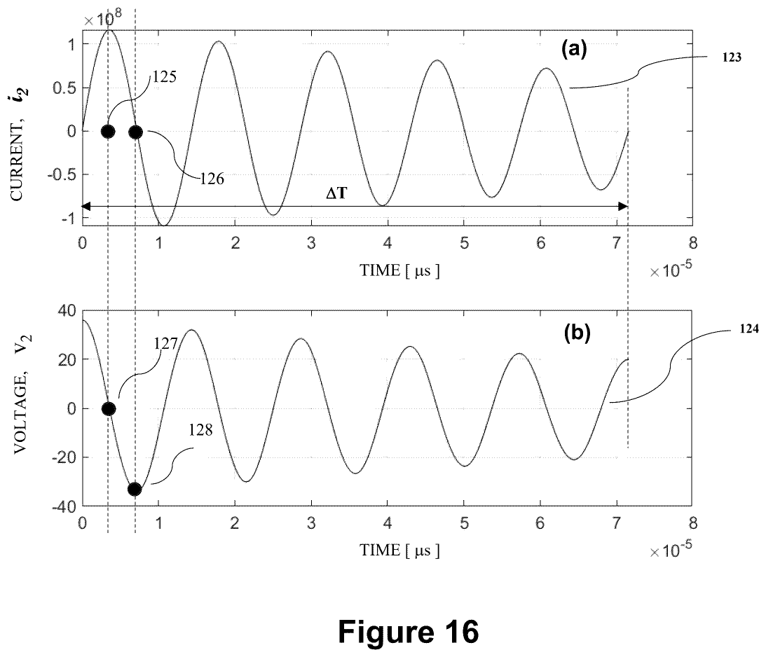

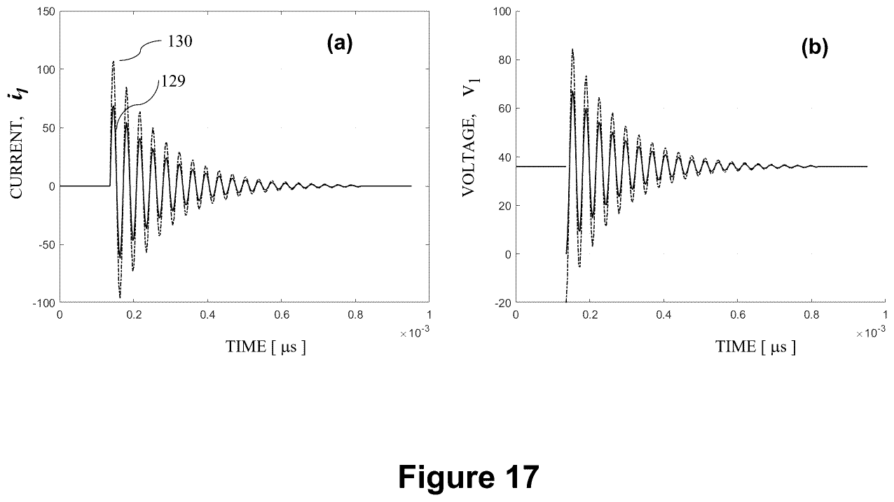

The battery heating rate is also proportional to the peak 121 of the oscillatory current waveform 119, FIG. 15(a), which is controlled by proper choice of the switch closing duration 114, FIG. 14. When electronic switch 108 is closed, FIG. 13, the LC tank circuit formed by capacitor 106 and external inductor 107 goes into oscillation. FIGS. 16(a) and 16(b) show the corresponding current 123 and voltage 124 waveforms, respectively. The external inductor 107, FIG. 13, is selected such that the discharge frequency is higher than the heating frequency. Time points labeled 127 and 128 in FIG. 16(b) show the value of capacitor 106 voltage at 0V and −36V (battery voltage). As discussed above, at the instant that electronic switch 108 opens, oscillatory current flows through the battery. FIG. 17(a) shows the current flow for the two switch opening positions 125 and 126, FIG. 16(a). The solid line 129 shows a peak current of 70 A for switch opening position 125 and the dashed line 130 shows a larger peak value of 110 A for switch opening position 126. The corresponding voltage waveforms are illustrated shown in the plots of FIG. 17(b).

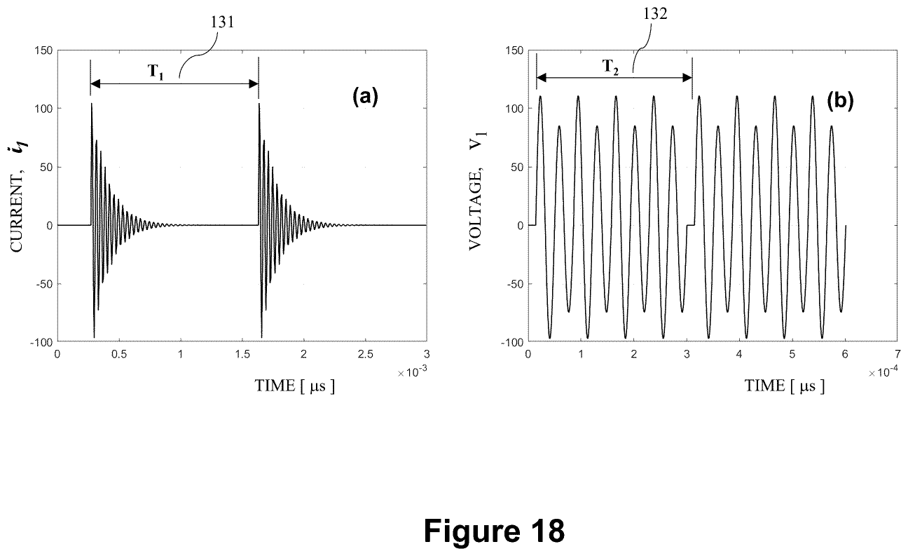

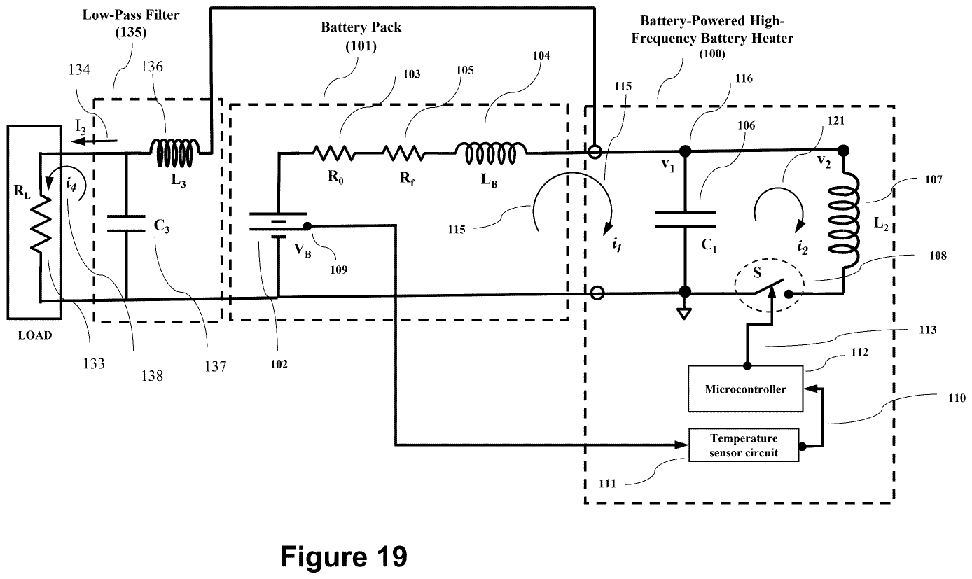

Another method for further increasing the battery heating rate is illustrated in FIG. 19. In this method, by terminating the heating current waveform 119, FIG. 15(a), prior to its nearly full damped width 122, its RMS value can be increased. For comparison, FIG. 18(a) illustrates the case when the repetition width 131 is longer than heating pulse width 122, thereby there is a long period of time between two high-frequency heating current pulses in which the amplitude of the current is either very small or is nearly zero. In contrast, the plot of FIG. 18(b) shows the case in which the repetition width 132 is significantly shorter than heating pulse width 122, FIG. 15(a), thereby the next pulse is initiated before the amplitude of the current has significantly decreased.

It is appreciated that as it was previously indicated, the frequency of the high-frequency battery heating current, FIG. 15(a), is a function of the battery inductance 104 (L_{B}), and any other inductances due to cables, etc., and the external capacitor 106 (C₁), FIG. 13. In many applications, it is desirable to adjust the frequency of the high-frequency battery heating current to achieve a higher or lower heating rate for optimal system performance. This goal is readily achieved by a simple modification to the circuit of the “Battery-Powered High-Frequency Battery Heater” embodiment 100 of FIG. 13 as shown in the schematic circuit of FIG. 13A. In this modification of the “Battery-Powered High-Frequency Battery Heater” embodiment 100, an inductor L_{E} is provided in the battery heating resonance circuit as shown in FIG. 13A. It is appreciated by those skilled in the art that by properly selecting the values of the inductance L_{E} and the capacitor C₁, the circuit designer can adjust the frequency of the high-frequency battery heating current, FIG. 15(a), to the desired value.

It is appreciated by those skilled in the art that with the first order model of the battery, FIG. 2, the location of the inductor L_{E} in the resonating circuit, i.e., being on either side of the capacitor C₁, is dependent on the available space in the device packaging and the “Battery-Powered High-Frequency Battery Heater” assembly.

The “Battery-Powered High-Frequency Battery Heater” embodiment 100 of FIG. 13 and its modified embodiment of FIG. 13A are shown and described for use to keep the battery temperature within a prescribed range in cold environments, i.e., when the environmental temperature is below the low set point of the indicated range.

However, in many applications, the “Battery-Powered High-Frequency Battery Heater” is to be provided to maintain the battery temperature within a prescribed range while the battery is powering the intended mobile or stationary load, such as a an electrically powered vehicle, truck, or utility vehicle, or the like, or a stationary back-up power or electrical energy storage systems. In such cases, depending on the design and operation of the load, it becomes necessary to ensure that the high-frequency battery heating (usually high) currents, do not interfere with the proper function of the load electrical and electronics. In such cases, band-reject or a low-pass filter will suffice may be used as described below avoid the high-frequency heating current interference with the proper operation of the load.

FIG. 19 shows how a load 133, i.e., a battery powered platform, may be connected to battery pack 101 that is provided with the “Battery-Powered High-Frequency Battery Heater” embodiment 100 of FIG. 13 or its modified embodiment of FIG. 13A. The battery powered platform may be an electrically powered vehicle, truck, lift-truck, or the like mobile or stationary platform.

In FIG. 19, the load R_{L} is also intended to include the battery resistance to DC current (as provided by the battery) and all component and wire related inductances (both usually relatively small).

It is appreciated that in the absence of the “Battery-Powered High-Frequency Battery Heater” circuit, FIGS. 13 and 13A, the load would draw a DC current 134 (I₃) from the batter pack 101.

When the “Battery-Powered High-Frequency Battery Heater” circuit, FIGS. 13 and 13A, is connected in parallel with the battery pack 101, then a filter 135 (low-pass or band reject), inside the enclosing dashed lined rectangle, is inserted between the load and the battery pack 101.

In the circuit illustrated, rejection of the high-frequency heating current is achieved by a combination of an inductor 136 and a capacitor 137. Component values are selected such that a proportion 138 (i₄) of the high frequency current 115 (i₁) being injected into the load is sufficiently small such that a voltage ripple produced by the oscillating heating current is negligible, typically voltage ripple below 5% is acceptable. The filter illustrated in FIG. 19 is one of many possible designs that could be used to reduce proportion 138 (i₄) of the heating frequency current 115 (i₁) to negligible levels.

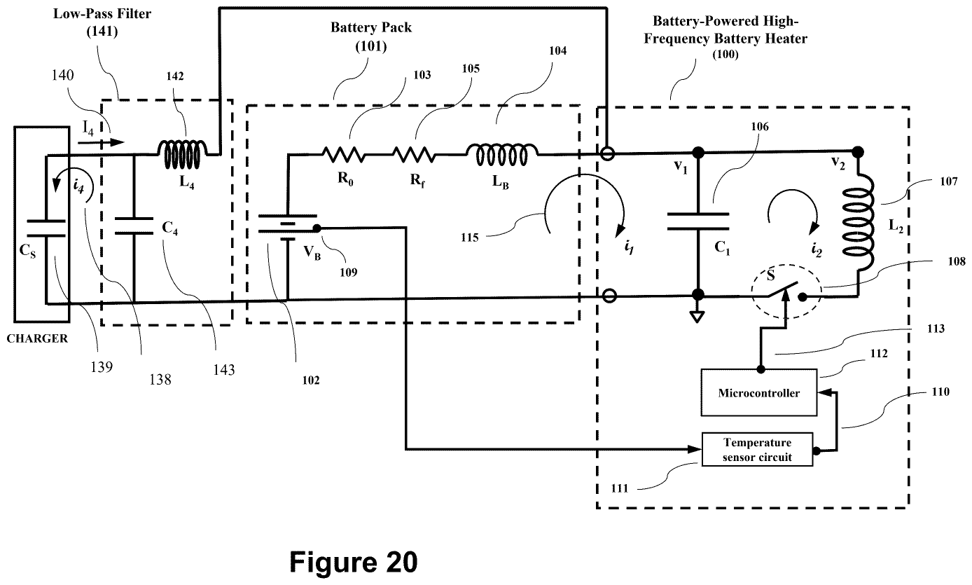

As indicated previously, there is also a need for methods and apparatus for “Battery-Powered High-Frequency Battery Heaters” that can be used to maintain a platform battery (battery pack) temperature within its optimal charging temperature range in colder than optimal environmental conditions while the platform battery (battery pack) is being charged. Such a system is described in the schematic circuit of FIG. 20.

FIG. 20 shows an exemplary configuration in which a charger and a “Battery-Powered High-Frequency Battery Heater” circuit, FIGS. 13 and 13A, are connected in parallel to battery pack 101. The output side of the charger typically has a large electrolytic capacitor 139. Damage to capacitor 139, due to the ripple voltage induced on the capacitor by injection of a proportion 140 (I₄) of the high-frequency heating current 115 (i₁), is avoided by not exceeding the rated voltage of capacitor 139. This is easily achieved by use of the low pass/band reject filter 141, constructed using a combination of an inductor 142 (L₄) and a capacitor 143 (C₄). Component values are selected such that a proportion 140 (I₄) of the high frequency current 115 (i₁) being injected into the battery 102 is sufficiently small such that the sum of the charging voltage and the ripple voltage is greater than zero and less than the voltage rating of the capacitor. The filter illustrated in FIG. 20 is one of many possible designs that could be used to reduce proportion 140 (I₄) of the high-frequency heating current 115 (i₁) to negligible levels.

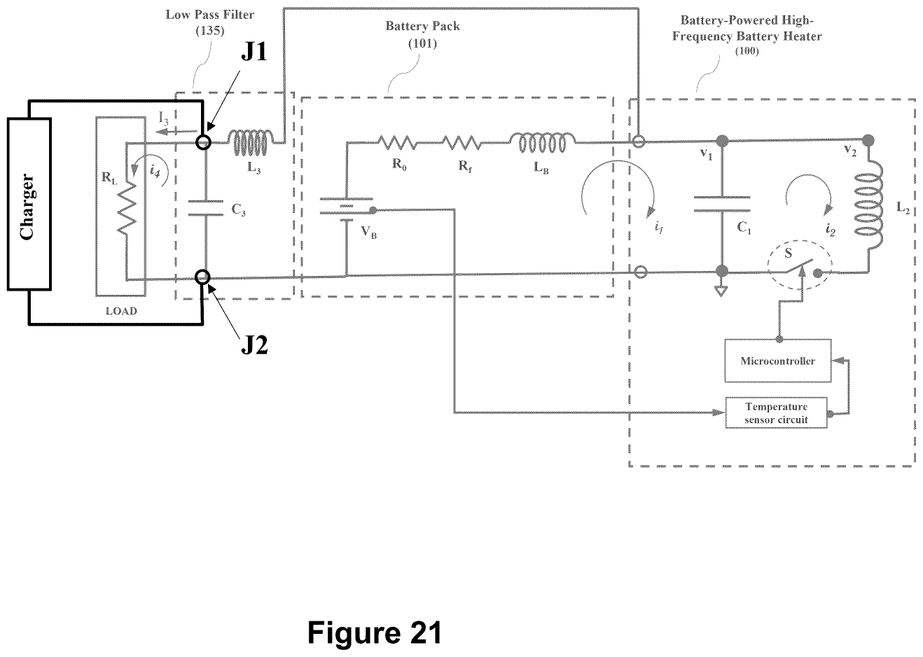

As indicated previously, there is also a need for methods and apparatus for “Battery-Powered High-Frequency Battery Heaters” that can be used to maintain a platform battery (battery pack) temperature above a specified minimum temperature that prevent damage to the battery until the time that the battery temperature must have been brought to within its optimal operational temperature for the platform to begin its service. This capability would allow the battery temperature to drop lower than the operational temperature of the battery for a fully or partially electrically powered platform, thereby significantly extending the amount of time that a “Battery-Powered High-Frequency Battery Heater” can keep the battery at such lower idle temperature so that it could be heated to its operational temperature range when needed. This capability is of particular importance to platforms that are primarily powered by internal combustion engines or other types of power generators, such as vehicles, trucks, snow removal vehicles, motorcycles, snowmobile, and the like, that are provided with electrical generators to keep their batteries charged. In such applications, while the platform is left idle in cold temperatures, the battery temperature could drop rapidly below the temperature at which it could provide enough power for the platform engine to be started. FIG. 21 shows how the “Battery-Powered High-Frequency Battery Heater” embodiment system of FIG. 19 may be used to address this application.

In FIG. 21, the “Battery-Powered High-Frequency Battery Heater” embodiment system of FIG. 19 is shown in grey color and the charger unit for charging the battery is shown to be connected to the system circuit at junctions J1 and J2, i.e., in parallel with the load. As a result, the high-frequency heating current, after it has been filtered as previously described by the Low Pass Filter (135), can enter the charger unit, thereby would not interfere with the operation of the charger in charging the battery (battery pack) with its provided DC charging current.

It is appreciated by those skilled in the art that when battery temperature is required by the charger controller unit, then the temperature sensor signal is also provided through an added wiring (not shown) from the battery site as was described for the battery temperature sensor 109 of FIG. 19.

FIG. 21 shows the “Battery-Powered High-Frequency Battery Heater” embodiment system of FIG. 19 together with its integrated charger unit that would be used in applications in which the platform is partially (as a hybrid system) or fully powered by other sources of energy, such as by an internal combustion engine. Such platforms are commonly provided with mechanically operated electrical generators that provide electrical energy to keep the platform battery fully charged and power the platform electrical and electronic systems. The platform batteries must also be capable of providing enough power for starting the platform internal combustion engines. Such platforms powered by internal combustion engines include various vehicles, trucks, motorcycles, snow removal vehicles, snowmobiles, utility vehicles, back-up power sources, etc., which also includes hybrid versions of such platforms.

However, it is appreciated by those skilled in the art that for platforms that are fully powered by stored battery power, the battery needs to be charged as the stored electrical energy of the battery is depleted, for example, as shown in the block diagram of FIG. 12. In this case, when the platform is provided with a “Battery-Powered High-Frequency Battery Heater” unit, then the “Platform Battery” must be disconnected from the “Battery-Powered High-Frequency Battery Heater” by disconnecting the connector 11, FIG. 11, and connecting the “Battery Platform” to the “Battery Charger” by the connector 13, FIG. 12.

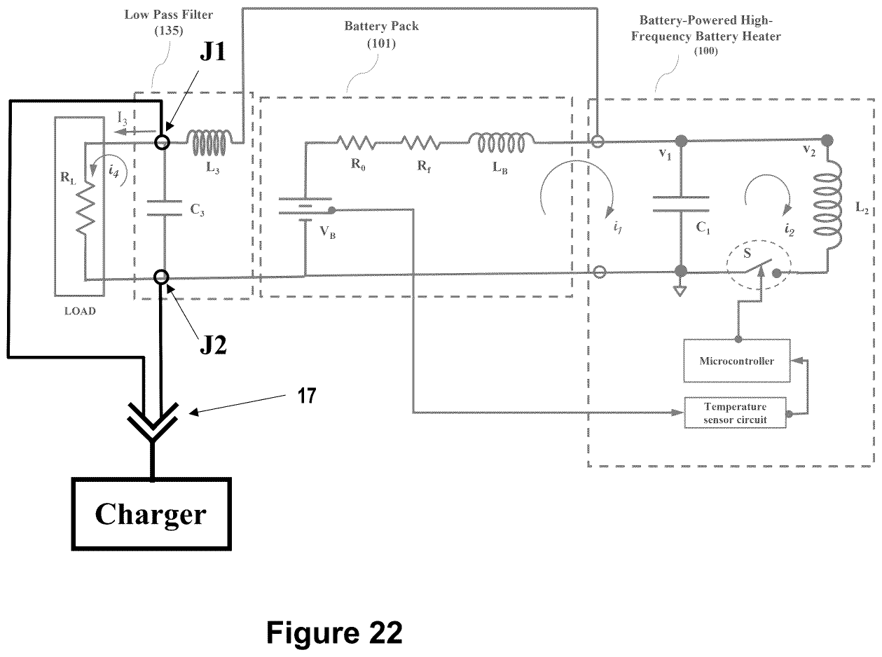

It is also appreciated by those skilled in the art that for Lithium-ion and other similar batteries (battery packs) that use safety and power management circuits (generally known as “Battery Management System” (BMS)) may also require filtering of the high-frequency heating current, depending on their design. In most cases, since BMS circuits are designed for detection of DC voltages and currents, they can tolerate high-frequency currents that may carry a negligible DC component. FIG. 22 shows how, when needed, a filtering circuit similar to those shown in FIGS. 19 and 20 may be configured with the battery (battery pack) and the BMS.

It is appreciated that the “Battery-Powered High-Frequency Battery Heater” of FIG. 11 is intended to be applicable to both applications in which the platform batteries are partially or fully powering the platform electrical load. Here, partially battery powered platforms include hybrid type vehicles (platforms) and platforms such as motorcycles, snowmobiles, and vehicles that are powered by internal combustion engines, in which the engine also drives an electric generator that is used to power the platform and keep the battery charged. In such cases, the “Battery-Powered High-Frequency Battery Heater” is usually permanently mounted as shown in the circuit schematic of FIG. 19, and also usually with the provided “Low-Pass Filter” to that the high-frequency current does not interfere with the operation of the platform (load) electrical and electronic components and circuits.

It is appreciated that in FIG. 11, the “Battery-Powered High-Frequency Battery Heater” is shown to be used in applications in which the platform is fully powered by the “Platform Battery”, such as electrically powered vehicles, trucks, lift-trucks, or the like mobile or stationary platforms. In which case, to charge the “Platform Battery” is usually disconnected at the connector 11, and connected to the charger connector, indicated as connector 13 in FIG. 12 and in the circuit schematic of FIG. 22.

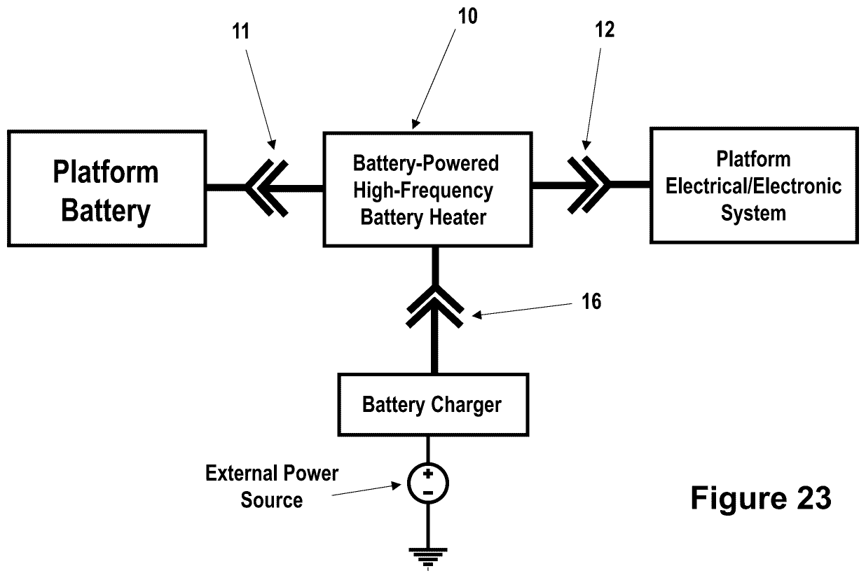

It is appreciated by those skilled in the art, that the circuit schematic of FIG. 22 may also be represented by its equivalent block diagram of FIG. 23. As can be seen in the block diagram of FIG. 23, similar to the block diagram of FIG. 11, the “Battery-Powered High-Frequency Heater” (with the provided low-pass filter, FIG. 22) is connected to the “Platform Battery” via the connector 11 on one side and to the “Platform Electrical/Electronic System” via the connector 12 on the other side. Then when the “Platform Battery” needs to be charged, the charger, which is powered by an “External Power Source” (i.e., line power), is connected to the “Battery-Powered High-Frequency Heater” connector 16.

It is also appreciated by those skilled in the art, that the advantage of the method presented by the block diagram of FIG. 23 over the method of charging the “Platform Battery” as shown in the block diagram of FIG. 12 is that since the “Battery-Powered High-Frequency Heater” is still active in maintaining the “Platform Battery” temperature within its prescribed optimal range, the “Platform Battery” is always charged while its temperature is within the prescribed optimal charging range, independent of the temperature of the platform environment. In comparison, if the “Platform Battery” is disconnected from the “Battery-Powered High-Frequency Heater” and is then connected to the “Battery Charger” as shown in the block diagram of FIG. 11, then when the platform and its “Platform Battery”, being exposed to the environmental conditions, can be cooled down in low temperature environments to temperatures that are below their optimal charging temperatures and be prevented from being charged. This can be a problem with Lithium-ion and the like batteries and in very cold environments. In addition, even when the battery can be fully charged, the battery temperature may still be below its optimal operating temperature range and incapable of providing enough power to the platform (load).

It is appreciated in the block diagram of FIG. 23, the “Battery-Powered High-Frequency Heater” is shown to be a separate device, which when needed, it is connected to the “Platform Battery” and the “Platform Electrical/Electronic System” of the platform via connectors 11 and 12, respectively. As such, the user may employ the device as needed.

It is also appreciated by those skilled in the art that alternatively, the “Battery-Powered High-Frequency Heater” may be integrated into the platform, for example, by integration into the “Platform Electrical/Electronic System”, and as a result, the platform user only needs to connect the “Battery Charger” to the platform inlet (shown as connector 16 in FIG. 23).

It is also appreciated that the method and system shown in the block diagram of FIG. 23 and its above alternative method of integration into the platform, for example, by integration into the “Platform Electrical/Electronic System” of the platform, may be applied to mobile and stationary platforms that are fully powered by provided “Platform Batteries”, as well as their hybrid powered platforms, as well as platforms that are primarily powered by internal combustion type systems or the like, for example those powered partially by sources such as fuel cells and the like, while they are also use battery power, for example for starting their engines and/or for powering other electrical and electronic components of the system.

It is appreciated by those skilled in the art that almost all electrochemical batteries, such as Lead-acid, Lithium-ion, and the like batteries and super-capacitors present a range of temperature within which the battery can be charged efficiently and with low long-term damage (usually defined as lowering of its cycle time and/or available power); a range of temperature within which the battery can efficiently and at peak current and without long-term damage can power a platform load; and a range of temperature within which the battery can be stored (i.e., have the platform using it be left idle and draw no or very low current, such as just to keep some electronic components powered) and be heated up to its charging and/or operational temperature range when it is needed. It is also appreciated by those skilled in the art that the above three temperature ranges are usually not the same. It is, therefore, highly desirable that the microcontroller (112 in FIGS. 19-22) of the “Battery-Powered High-Frequency Heater” and its user interface device(s) be programmed and be provided with the capability of being set by the user to set the range of temperatures and their timing to match the requirements of each application in each usage scenario to minimize the level of electrical energy that is needed to keep the platform system ready for service, while minimizing the overall cost of the platform system operation, maintenance, service, and battery replacement. This, for example, is usually the case since the above storage temperature is usually significantly lower than charging and operational temperature, and by lowering the temperature at which platform batteries are maintained in cold temperature without causing any short and/or long-term damage to the battery, then the amount of energy (usually electrical or otherwise storage space) that is required is significantly reduced.

In general, to satisfy the above capabilities, the platform user may require user interface input to enable one or more of the following capabilities to address the related operational scenarios:
1—The capability of setting the time(s) of the day(s) (as needed) at which the platform must be ready for service, i.e., the “Platform Battery” must be fully charged, and its temperature must be within its optimal platform operating range, otherwise be kept within its optimal storage temperature range and charged fully or to a prescribed level. It is appreciated by those skilled in the art that the “Battery-Powered High-Frequency Heater” (e.g., FIGS. 19 and 20) must then be also provided a temperature sensor and temperature sensor circuit (not shown), similar to those of 109 and 111, FIGS. 19 and 20, to provide the temperature of the environment to the system “Microcontroller” 112 to implement the above capability.
2—The capability of setting the time(s) and day(s) (as needed) at which the platform must be ready for service, i.e., the “Platform Battery” must be fully charged, and its temperature must be within its optimal platform operating range, and that while the platform is in service, the “Platform Battery” temperature be maintained within a prescribe optimal range so that it would allow the following capabilities:
   a. For electrically powered platforms, such as electric vehicles (EV), trucks, lift-trucks, electrical energy storage stations, battery powered back-up power sources, and the like, to provide the capability for the “Platform Battery” maintain the battery temperature within its optimal operating range as long as possible in each particular application and environment while the electrically powered platform is idle in between service. For example, an electrically powered truck carrying cargo from one point to the other, may stop at a rest stop to rest for a period of time, during which the “Platform Battery” temperature needs to be maintained within its optimal operating range using a portion the “Platform Battery” power.
   b. For partially powered platforms, such as vehicles powered by internal combustion engines and that use the “Platform Battery” to start the engine and power electrical and electronic and the like components and systems of the vehicle, to provide the capability of keeping the “Platform Battery” fully charged and its temperature maintained with an optimal temperature range so that when the platform engine has been turned off, the “Platform Battery” can provide enough power to restart it, even if the platform engine has been turned off for a relatively long periods of time. It is appreciated that in such partially powered platforms, while the engine is running, engine power is also used to generate electrical energy using an electrical generator that is used to keep the battery charged and directly or through the battery power the electrical and electronic components of the vehicle.
   c. It is also appreciated by those skilled in the art that the above user capabilities may be applied by the user through various provided user methods and devices, such as by the user inputting the timing, temperature settings and other required information manually though a provided touch button screens, buttons, etc., or via a selection menu, or via a wireless connection and a provided secure app, even remotely, or the like.

It is appreciated by those skilled in the art that in many applications of the disclosed and similar battery heating applications of the embodiments, users would like the capability of disabling the “Battery-Powered High-Frequency Heater”, such as when the environmental temperature is not low or is not expected to be low for a long enough period. For this reason, the “Battery-Powered High-Frequency Heater” can be provided with enable/disable switches that terminate high-frequency heating current production, which are activated manually or via the system control pad or through any other system interfacing method and device described previously.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

1. A method of maintaining a temperature of an energy storage device for an electrical platform, the energy storage device having an electrolyte with ions and an internal inductance, the method comprising:
charging a capacitor coupled in parallel to the energy storage device;
determining whether the energy storage device is in use for the electrical platform;
monitoring a temperature of the energy storage device, wherein the energy storage device has a prescribed temperature range and an operational temperature range, the prescribed temperature range having an upper prescribed temperature limit which is below an upper operational temperature limit of the operational temperature range and having a lower prescribed temperature limit that is below a lower operational temperature limit of the operational temperature range;
discharging the capacitor through an inductor by temporary actuation of a switch which during actuation, couples the inductor in parallel to the capacitor, wherein oscillation of current and voltage is provided by a first circuit formed by the capacitor and the inductor,
maintaining the energy storage device temperature within a given temperature range through oscillation of the ions due to high frequency oscillation of a second circuit formed by the capacitor and the internal inductance of the energy storage device following termination of the actuation,
repeating the temporary reactuation of the switch while the temperature is within the given temperature range,
wherein the given temperature range is the prescribed temperature range when the energy storage device is not being used and is the operational temperature range when the energy storage device is being used.

2. The method of claim 1, comprising discontinuing the repeating of the reactuation of the switch when the temperature is above the upper prescribed temperature limit when the energy storage device is not in use and discontinuing the reactuation of the switch when the temperature is above the upper operational temperature limit when the energy storage device is in use.

3. The method of claim 1, wherein a duration of the temporary actuation is at least equal to one quarter of the oscillation of the current or the voltage of the first circuit, and is equal or less than one half of the oscillation of the current or the voltage of the first circuit.

4. The method of claim 1, the repeating the temporary actuation comprising repeating the temporary actuation prior to voltage across the capacitor steadying to a voltage of the energy storage device.

5. The method of claim 1, comprising providing a low pass filter for coupling between the capacitor and the electrical platform thereby reducing current reaching the electrical platform due to the high frequency oscillation to below a predetermined threshold.

6. The method of claim 1, comprising providing a low pass filter for coupling between the capacitor and a charger for the energy storage device thereby reducing current reaching the charger due to the high frequency oscillation to below a predetermined threshold.

7. The method of claim 1, comprising charging the energy storage device when the energy storage device is within at least one of the prescribed temperature range and the operational temperature range.

8. The method of claim 1, comprising receiving an indication that the energy storage device is not going to be used for a long duration and in response to the indication, maintaining the energy storage device temperature within a storage temperature range through the high frequency oscillation of the second circuit following termination of the actuation, wherein the storage temperature range is a lower temperature range than the prescribed temperature range.

9. A method of heating an energy storage device for an electrical platform, the energy storage device having an electrolyte with ions and an internal inductance, the method comprising:
charging a capacitor coupled in parallel to the energy storage device;
determining whether the energy storage device is in use for the electrical platform;
monitoring a temperature of the energy storage device, wherein the energy storage device has a prescribed temperature range and an operational temperature range, the prescribed temperature range having an upper prescribed temperature limit which is below an upper operational temperature limit of the operational temperature range and having a lower prescribed temperature limit that is below a lower operational temperature limit of the operational temperature range;
discharging the capacitor through an inductor by temporary actuation of a switch which during actuation, couples the inductor in parallel to the capacitor, wherein oscillation of current and voltage is provided by a first circuit formed by the capacitor and the inductor,
heating the energy storage device to a given temperature range through oscillation of the ions due to high frequency oscillation of a second circuit formed by the capacitor and the internal inductance of the energy storage device following termination of the actuation,
repeating the temporary reactuation of the switch while the temperature is within the given temperature range thereby continuing the energy storage device heating, and
discontinuing the reactuation of the switch when the temperature is above the given temperature limit,
wherein the given temperature range is the prescribed temperature range when the energy storage device is not being used and is the operational temperature range when the energy storage device is being used.

10. A device for maintaining a temperature of an energy storage device for an electrical platform, the energy storage device having an electrolyte with ions and an internal inductance, the device comprising:
a capacitor having first and second couplings for coupling the capacitor in parallel to the energy storage device when the device is coupled to the energy storage device;
a switch;
an inductor coupled in parallel to the capacitor through the switch when the switch is actuated; and
a controller configured to actuate the switch, determine whether the energy storage device is in use for the electrical platform, and to monitor a temperature of the energy storage device when the energy storage device is coupled to the device, the controller being further configured to maintain the energy storage device within a prescribed temperature range and an operational temperature range, the prescribed temperature range having an upper prescribed temperature limit which is below an upper operational temperature limit of the operational temperature range and having a lower prescribed temperature limit that is below a lower operational temperature limit of the operational temperature range;
wherein, when the energy storage device is coupled to the device, the controller being configured to
discharge the capacitor through the inductor by temporary actuation of the switch which during actuation, oscillation of current and voltage is provided by a first circuit formed by the capacitor and the inductor,
maintain the energy storage device temperature within a given temperature range through oscillation of the ions due to high frequency oscillation of a second circuit formed by the capacitor and the internal inductance of the energy storage device following termination of the actuation, and
repeat the temporary reactuation of the switch to maintain the energy storage device temperature within the given temperature range, and
wherein the controller is configured to maintain the energy storage device within the prescribed temperature range when the energy storage device is not being used and is configured to maintain the energy storage device within the operational temperature range when the energy storage device is being used.

11. The device of claim 10, wherein the controller is configured to discontinue the reactuation of the switch when the temperature is above the upper prescribed temperature limit when the energy storage device is not in use and is configured to discontinue the reactuation of the switch when the temperature is above the upper operational temperature limit when the energy storage device is in use.

12. The device of claim 10, wherein the controller is configured to provide a user interface to receive an indication of when the electrical platform is to be used and is configured to bring the temperature of the energy storage device to the operational temperature range when the electrical platform is indicated to be used.

13. The device of claim 12, wherein the controller is configured to provide the user interface to receive an indication that the energy storage device is not going to be used for a long duration and in response to the indication, the controller is configured to maintain the energy storage device temperature within a storage temperature range through the high frequency oscillation of the second circuit following termination of the actuation, wherein the storage temperature range is a lower temperature range than the prescribed temperature range.

14. The device of claim 10, wherein the controller is configured to provide a user interface to receive an indication to enable and disable operation of the device.

15. The device of claim 11, wherein the controller is configured to provide a duration of the temporary actuation to be at least equal to one quarter of the oscillation of the current or the voltage of the first circuit, and is equal or less than one half of the oscillation of the current or the voltage of the first circuit.

16. The device of claim 11, wherein the controller is configured to repeat the temporary actuation prior to voltage across the capacitor steadying to a voltage of the energy storage device.

17. The device of claim 11, wherein the inductor is a first inductor, the device comprising a second inductor, wherein the first coupling is coupled to the energy storage device serially through the second inductor to adjust the high frequency to a determined frequency.

18. The device of claim 11, comprising a low pass filter for coupling between the device and the electrical platform, the low pass filter being configured to reduce current reaching the electrical platform due to the high frequency oscillation to below a predetermined threshold.

19. The device of claim 11, comprising a low pass filter for coupling between the device and a charger for the energy storage device, the low pass filter being configured to reduce current reaching the charger due to the high frequency oscillation to below a predetermined threshold.

20. The device of claim 11, wherein the energy storage device is one of a battery or a super capacitor.
